(19) United States
(12) Patent Application Publication
(10) Pub. No.: US 2016/0275431 A1
(43) Pub. Date: Sep. 22, 2016

(54) Employee Evaluation System

(71) Applicant: ADP, LLC, Roseland, NJ (US)

(72) Inventors: Jerome Gouvernel, Brooklyn, NY (US); Hadar Yacobovitz, New York, NY (US)

(21) Appl. No.: 14/662,049

(22) Filed: Mar. 18, 2015

(51) Int. Cl. G06Q 10/06; G06F 3/0484; G06F 3/0482

(52) U.S. Cl. CPC G06Q 10/06393; G06F 3/0482; G06F 3/04842

(57) ABSTRACT

A method for graphically displaying data within an employee evaluation system that identifies relative performance of employees is presented. Locations of employee evaluations are identified on a chart that is graphically displayed on a graphical user interface of a display system. Performance results for the employees are identified. The performance results are compared to ideal performance results. The comparison of the performance results to the ideal performance results is displayed on a graph on the graphical user interface. Displaying the chart and graph on a graphical user interface enables identification of relative performance of the group of employees.

### BACKGROUND INFORMATION

1. Field

The present disclosure relates generally to an improved data processing system. In particular, the present disclosure relates to a method and apparatus for evaluating employees in an organization. Still more particularly, the present disclosure relates to a method and apparatus for eliminating in group bias when evaluating employees to facilitate an evenhanded evaluation therefore when displayed in a graphical user interface.

2. Background

Information systems are used for many different purposes. For example, an information system may be used to process payroll to generate paychecks for employees in an organization. Additionally, an information system also may be used by supervisors within the organization and a human resources department to maintain and visualize records about employees. For example, a supervisor may record and visualize employee evaluations using various charts displayed within an employee information system. For example, bar graphs, line graphs, circular charts, and other types of charts or graphs may be used to provide a graphical representation of the information.

Current systems displaying information to facilitate employee evaluations lack capabilities to eliminate in group bias of a supervisor for certain employees. As a result, current employee evaluation systems often overestimate the abilities and performance of employees reviewed by their supervisor.

Therefore, it would be desirable to have a method and apparatus that take into account at least some of the issues discussed above, as well as other possible issues. For example, it would be desirable to have a method and apparatus that overcome issues with employee evaluation systems that result in biased evaluations of the employees.

### SUMMARY

In one illustrative embodiment, a graphical display system comprises a computer system and an employee evaluation system for identifying relative performance of employees in communication with the display system. The computer system identifies locations for a group of employee evaluations on a two axis chart that is to be graphically displayed on a display system. The computer system identifies performance results for the group of employees that is to be graphically displayed on the display system. The computer system compares the performance results to ideal performance results. The computer system displays the group of employees on the two axis chart of the graphical user interface and display system. The first axis is a potential and performance for the group of employees. The second axis is an actual performance of the group of employees. The computer system displays the comparison of the performance results to the ideal performance results on a graph on the graphical user interface. Displaying the chart and graph on a graphical user interface enables identification of relative performance of the group of employees.

Based on the comparison between the performance results in the ideal performance result, the computer system may further include graphically displaying a recommendation to rationalize the performance results to an ideal performance results. The computer system identifies a recommendation for a rationalized performance result that more closely approximate the performance results to the ideal performance results. The computer system displays the recommendation for the rationalized performance results on the two axis chart of the graphical user interface and display system. Displaying the recommendation for a rationalized performance result chart on the two axis chart of the graphical user interface and display system enables remediation of in group bias that may be present within the performance results.

In another illustrative embodiment, a method for graphically displaying data within an employee evaluation system that identifies relative performance of employees is presented. A computer system identifies locations for a group of employee evaluations on a two axis chart that is to be graphically displayed on a display system. The computer system identifies performance results for the group of employees that is to be graphically displayed on the display system. The computer system compares the performance results to ideal performance results. The computer system displays the group of employees on the two axis chart of the graphical user interface and display system. The first axis is a potential and performance for the group of employees. The second axis is an actual performance of the group of employees. The computer system displays the comparison of the performance results to the ideal performance results on a graph on the graphical user interface. Displaying the chart and graph on a graphical user interface enables identification of relative performance of the group of employees.

Based on the comparison between the performance results in the ideal performance result, the method may further include graphically displaying a recommendation to rationalize the performance results to an ideal performance results. The computer system may further identify a recommendation for a rationalized performance result that more closely approximate the performance results to the ideal performance results. The computer system displays the recommendation for the rationalized performance results on the two axis chart of the graphical user interface and display system. Displaying the recommendation for a rationalized performance result chart on the two axis chart of the graphical user interface and display system enables remediation of in group bias that may be present within the performance results.

In yet another illustrative embodiment, a computer program product for graphically displaying data within an employee evaluation system that identifies relative performance of employees comprises a computer readable storage media, and program code stored on the computer readable storage media. The program code instructs the employee evaluation system to identify locations for a group of employee evaluations on a two axis chart that is to be graphically displayed on a display system. The program code instructs the employee evaluation system to identify performance results for the group of employees that is to be graphically displayed on the display system. The program code instructs the employee evaluation system to compare the performance results to ideal performance results. The program code instructs the employee evaluation system to display the group of employees on the two axis chart of the graphical user interface and display system. The first axis is a potential and performance for the group of employees. The second axis is an actual performance of the group of employees. The program code instructs the employee evaluation system to display the comparison of the performance results to the ideal performance results on a graph on the graphical user interface. Displaying the chart and graph on a graphical user interface enables identification of relative performance of the group of employees.

Based on the comparison between the performance results in the ideal performance result, the computer program product may further include program code for graphically displaying a recommendation to rationalize the performance results to an ideal performance results. The program code may further instruct the employee evaluation system to identify a recommendation for a rationalized performance result that more closely approximate the performance results to the ideal performance results. The program code instructs the employee evaluation system to display the recommendation for the rationalized performance results on the two axis chart of the graphical user interface and display system. Displaying the recommendation for a rationalized performance result chart on the two axis chart of the graphical user interface and display system enables remediation of in group bias that may be present within the performance results

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an employee evaluation environment depicted in accordance with an illustrative embodiment;

FIG. 2 is an illustration of a graphical user interface in an employee evaluation system depicted in accordance with an illustrative embodiment;

FIG. 3 is an illustration of an employee list within a graphical user interface depicted in accordance with an illustrative embodiment;

FIG. 4 is an illustration of an employee evaluation chart within a graphical user interface depicted in accordance with an illustrative embodiment;

FIG. 5 is an illustration of an aggregate evaluation graph within a graphical user interface depicted in accordance with an illustrative embodiment;

FIG. 6A is an illustration of a first example an interactive relationship between an evaluation chart and an aggregate evaluation graph for a single employee within a graphical user interface is depicted in accordance with an illustrative embodiment;

FIG. 6B is an illustration of a second example an interactive relationship between an evaluation chart and an aggregate evaluation graph for a single employee within a graphical user interface is depicted in accordance with an illustrative embodiment;

FIG. 6C is an illustration of a third example an interactive relationship between an evaluation chart and an aggregate evaluation graph for a single employee within a graphical user interface is depicted in accordance with an illustrative embodiment;

FIG. 6D is an illustration of a fourth example an interactive relationship between an evaluation chart and an aggregate evaluation graph for a single employee within a graphical user interface is depicted in accordance with an illustrative embodiment;

FIG. 6E is an illustration of a fifth example an interactive relationship between an evaluation chart and an aggregate evaluation graph for a single employee within a graphical user interface is depicted in accordance with an illustrative embodiment;

FIG. 7A is an illustration of a first example an interactive relationship between an evaluation chart and an aggregate evaluation graph for two employee having a distribution below acceptable tolerances within a graphical user interface is depicted in accordance with an illustrative embodiment;

FIG. 7B is an illustration of a second example an interactive relationship between an evaluation chart and an aggregate evaluation graph for two employee having a distribution below acceptable tolerances within a graphical user interface is depicted in accordance with an illustrative embodiment;

FIG. 7C is an illustration of a third example an interactive relationship between an evaluation chart and an aggregate evaluation graph for two employee having a distribution below acceptable tolerances within a graphical user interface is depicted in accordance with an illustrative embodiment;

FIG. 7D is an illustration of a fourth example an interactive relationship between an evaluation chart and an aggregate evaluation graph for two employee having a distribution below acceptable tolerances within a graphical user interface is depicted in accordance with an illustrative embodiment;

FIG. 7E is an illustration of a first example an interactive relationship between an evaluation chart and an aggregate evaluation graph for two employee having a distribution within acceptable tolerances within a graphical user interface is depicted in accordance with an illustrative embodiment;

FIG. 7F is an illustration of a second example an interactive relationship between an evaluation chart and an aggregate evaluation graph for two employee having a distribution within acceptable tolerances within a graphical user interface is depicted in accordance with an illustrative embodiment;

FIG. 7G is an illustration of a third example an interactive relationship between an evaluation chart and an aggregate evaluation graph for two employee having a distribution within acceptable tolerances within a graphical user interface is depicted in accordance with an illustrative embodiment;

FIG. 7H is an illustration of a fourth example an interactive relationship between an evaluation chart and an aggregate evaluation graph for two employee having a distribution within acceptable tolerances within a graphical user interface is depicted in accordance with an illustrative embodiment;

FIG. 7I is an illustration of a fifth example an interactive relationship between an evaluation chart and an aggregate evaluation graph for two employee having a distribution within acceptable tolerances within a graphical user interface is depicted in accordance with an illustrative embodiment;

FIG. 7J is an illustration of a sixth example an interactive relationship between an evaluation chart and an aggregate evaluation graph for two employee having a distribution within acceptable tolerances within a graphical user interface is depicted in accordance with an illustrative embodiment;

FIG. 7K is an illustration of a seventh example an interactive relationship between an evaluation chart and an aggregate evaluation graph for two employee having a distribution within acceptable tolerances within a graphical user interface is depicted in accordance with an illustrative embodiment;

FIG. 7L is an illustration of a first example an interactive relationship between an evaluation chart and an aggregate evaluation graph for two employee having a distribution above acceptable tolerances within a graphical user interface is depicted in accordance with an illustrative embodiment;

FIG. 7M is an illustration of a second example an interactive relationship between an evaluation chart and an aggregate evaluation graph for two employee having a distribution above acceptable tolerances within a graphical user interface is depicted in accordance with an illustrative embodiment;

FIG. 7N is an illustration of a third example an interactive relationship between an evaluation chart and an aggregate evaluation graph for two employee having a distribution above acceptable tolerances within a graphical user interface is depicted in accordance with an illustrative embodiment;

FIG. 7O is an illustration of a fourth example an interactive relationship between an evaluation chart and an aggregate evaluation graph for two employee having a distribution above acceptable tolerances within a graphical user interface is depicted in accordance with an illustrative embodiment;

FIG. 8 is an illustration of an evaluation chart and an aggregate evaluation graph for a first biased evaluation of group of employee within a graphical user interface depicted in accordance with an illustrative embodiment;

FIG. 9 is an illustration of an evaluation chart and an aggregate evaluation graph for a second biased evaluation of group of employee within a graphical user interface depicted in accordance with an illustrative embodiment;

FIG. 10 is an illustration of a suggestion for an employee displayed in an evaluation chart within a graphical user interface depicted in accordance with an illustrative embodiment;

FIG. 11 is an illustration of an evaluation chart and an aggregate evaluation graph for rationalized evaluations of group of employee within a graphical user interface depicted in accordance with an illustrative embodiment;

FIG. 12A is an illustration of employee interaction within a graphical user interface depicted in accordance with an illustrative embodiment;

FIG. 12B is an illustration of employee interaction showing callouts for the employee within a graphical user interface depicted in accordance with an illustrative embodiment;

FIG. 12C is an illustration of employee interaction showing employee highlights for the employee within a graphical user interface depicted in accordance with an illustrative embodiment;

FIG. 12D is an illustration of employee interaction showing employee notations for the employee within a graphical user interface depicted in accordance with an illustrative embodiment;

FIG. 12E is an illustration of employee interaction showing a notation count within a graphical user interface depicted in accordance with an illustrative embodiment;

FIG. 12F is an illustration of employee interaction showing an employee profile within a graphical user interface depicted in accordance with an illustrative embodiment;

FIG. 13 is an illustration of relative movement of an employee within fields of evaluation chart for selected time intervals displayed in a graphical user interface depicted in accordance with an illustrative embodiment;

FIG. 14 is an illustration of chart filters within a graphical user interface depicted in accordance with an illustrative embodiment;

FIG. 15A is an illustration of an interactive relationship between chart filters and an evaluation chart within a graphical user interface depicted in accordance with an illustrative embodiment;

FIG. 15B is an illustration of an interactive relationship between chart filters and an evaluation chart showing a selection of a direct/indirect report toggle within a graphical user interface depicted in accordance with an illustrative embodiment;

FIG. 15C is an illustration of an interactive relationship between chart filters and an evaluation chart showing a selection of a team color toggle within a graphical user interface depicted in accordance with an illustrative embodiment;

FIG. 15D is an illustration of an interactive relationship between chart filters and an evaluation chart showing a selection of a group teams toggle within a graphical user interface depicted in accordance with an illustrative embodiment;

FIG. 15E is an illustration of an interactive relationship between chart filters and an evaluation chart wing a selection of a single one of plurality of teams toggles within a graphical user interface depicted in accordance with an illustrative embodiment;

FIG. 15F is an illustration of an interactive relationship between chart filters and an evaluation chart showing a selection of two of plurality of teams toggles within a graphical user interface depicted in accordance with an illustrative embodiment;

FIG. 16 is an illustration of a time line within a graphical user interface depicted in accordance with an illustrative embodiment;

FIG. 17 is an illustration of a flowchart of a process for receiving employee evaluations in an employee evaluation system shown according to an illustrative embodiment;

FIG. 18 is an illustration of a flowchart of a process for determining a current distribution of employee evaluations shown according to an illustrative embodiment;

FIG. 19 is an illustration of a flowchart of a process for making a suggestion to biased employee evaluations is shown according to an illustrative embodiment; and

FIG. 20 is an illustration of a block diagram of a data processing system depicted in accordance with an illustrative embodiment.

### DETAILED DESCRIPTION

The illustrative embodiments recognize and take into account one or more different considerations. For example, the illustrative embodiments recognize and take into account that currently used techniques for evaluating and displaying employee evaluations may not be as clear as possible to convey information, such as user bias, to a person viewing the chart. The illustrative embodiments recognize and take into account that current techniques for displaying employee evaluations often result in undesirable in group bias that is not quickly and clearly conveyed.

The illustrative embodiments recognize and take into account that evaluating employees within an employee evaluation system that are free of in group bias may be more difficult to compare than desired. The illustrative embodiments also recognize and take into account that maintaining evenhanded evaluation of employees assigned to different groups within the organization may be more difficult than desired.

Thus, the illustrative embodiments provide a method and apparatus for graphically displaying data within an employee evaluation system that identifies relative performance of employees is presented. A computer system identifies locations for a group of employee evaluations on a two axis chart that is to be graphically displayed on a display system. The computer system identifies performance results for the group of employees that is to be graphically displayed on the display system. The computer system compares the performance results to ideal performance results. The computer system displays the group of employees on the two axis chart of the graphical user interface and display system. The first axis is a potential and performance for the group of employees. The second axis is an actual performance of the group of employees. The computer system displays the comparison of the performance results to the ideal performance results on a graph on the graphical user interface. Displaying the chart and graph on a graphical user interface enables identification of relative performance of the group of employees.

Based on the comparison between the performance results in the ideal performance result, the method may further include graphically displaying a recommendation to rationalize the performance results to an ideal performance results. The computer system may further identify a recommendation for a rationalized performance result that more closely approximate the performance results to the ideal performance results. The computer system displays the recommendation for the rationalized performance results on the two axis chart of the graphical user interface and display system. Displaying the recommendation for a rationalized performance result chart on the two axis chart of the graphical user interface and display system enables remediation of in group bias that may be present within the performance results.

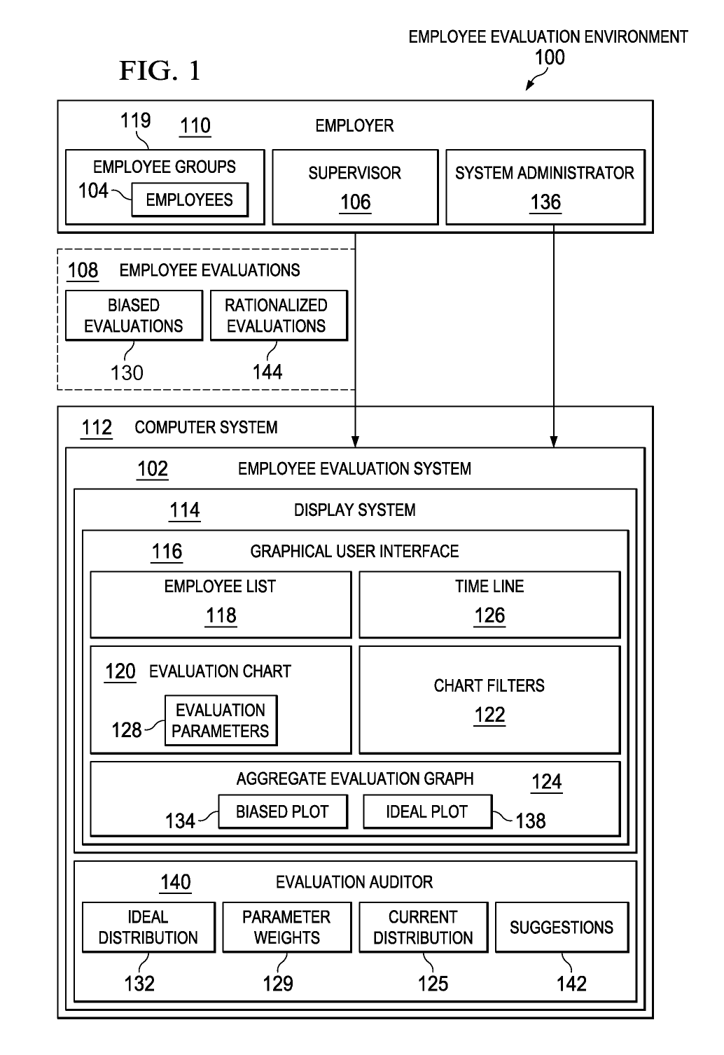

With reference now to the figures and in particular with reference to FIG. 1, an illustration of a block diagram of an employee evaluation environment is depicted in accordance with an illustrative embodiment. Employee evaluation environment 100 includes employee evaluation system 102. Employee evaluation system 102 is used to perform operations with respect to employees 104. The operations can be, for example but not limited to, at least one of evaluating employees 104 through activities to be performed by supervisor 106, and auditing employee evaluations 108. The activities to be performed by supervisor 106 can be, for example but not limited to, submission of employee evaluations 108. As depicted, employees 104 are people who are employed by or associated with an entity for which employee evaluation system 102 is implemented, such as employer 110. As depicted, supervisor 106 are people who are employed by or associated with an entity, such as employer 110, and who are responsible for evaluation, training, or supervision of employees 104.

Employee evaluation system 102 can be implemented in computer system 112, where the computer system is a hardware system includes one or more data processing systems. When more than one data processing system is present, those data processing systems may be in communication with each other using a communications medium. The communications medium may be a network. The data processing systems may be selected from at least one of a computer, a workstation, a server computer, a tablet computer, a laptop computer, a mobile phone, a personal digital assistant (PDA), or some other suitable data processing system.

Employee evaluations 108 are assessments of at least one of various characteristics, qualities, or performances of employees 104. Employee evaluations 108 can include subjective assessment of employees 104 based on a qualitative review of employees 104. The subjective assessment can include opinions about employees 104, such as at least one of the opinions of supervisor 106 about employees 104, the opinions of clients of employer 100 about employees 104, and the opinions of other ones of employees 104. Employee evaluations 108 can also include objective assessments of employees 104 based on a based on a quantitative review of employees 104, including quantifiable metrics about employees 104 tracked by employer 110.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, employee evaluation system 102 includes display system 114. In this illustrative example, display system 114 can be a group of display devices. A display device in display system 114 may be selected from one of a liquid crystal display (LCD), a light emitting diode (LED) display, an organic light emitting diode (OLED) display, and other suitable types of display devices.

In this illustrative example, display system 114 includes graphical user interface 116. In this illustrative example, employee evaluation system 102 can display information such as for example, at least one of the employee list 118, evaluation chart 120, chart filters 122, aggregate evaluation graph 124, and timeline 126, and other suitable information in graphical user interface 116.

Employee list 118 is a graphical indication of at least one of employees 104, employee group 119, or any group or subgroup thereof, for which supervisor 106 enters employee evaluations 108. For example, employee list 118 can depict employee group 119. Employee groups 119 are logical groupings of a subset of employees 104 sharing at least one common attribute relating to employer 110. For example, employee groups 119 can be, but not limited to, employees 104 that are direct reports of supervisor 106, employees 104 that are indirect reports of supervisor 106, employees 104 assigned to a same team of employer 110, employees 104 assigned to a department of employer 110, as well as other groups and subgroups of employees 104.

As used herein, a direct report is one of employees 104 whose position with employer 110 is directly below that of supervisor 106, and is managed by supervisor 106. As used herein, an indirect report is one of employees 104 whose position with employer 110 is below that of supervisor 106, and is managed by a direct report or another indirect report of supervisor 106.

Evaluation chart 120 is an interactive graphical chart by which employee evaluation system 102 receives and displays employee evaluations 108. In the illustrative embodiment, evaluation chart 120 is a multi-axis grid on which supervisor 106 can enter assessments of at least one of various characteristics, qualities, or performances of employees 104.

To facilitate comparison of the various characteristics, qualities, and performances of employees 104 included in employee evaluations 108, employee evaluation system 102 plots evaluation parameters 128 along the axes of evaluation chart 120. Evaluation parameters 128 are various characteristics, qualities, or performances of employees 104 included in employee evaluations 108. By displaying evaluation parameters 128 plotted along the axes of evaluation chart 120, employee evaluation system 102 facilitates an evenhanded evaluation of employees without overemphasis on a particular characteristic, quality, or performance of employees 104.

Evaluation parameters 128 can be assigned separate parameter weights 129. Parameter weights 129 are weighting factors that can be applied to emphasize certain ones of evaluation parameters 128 when determining the relative performance among employees 104.

Chart filters 122 are various view filters that can be applied to employees 104 displayed in evaluation chart whose. Chart filters 122 can filter employees 104 within evaluation 120 based on, for example but not limited to employee groups 119. Additionally, chart filters 122 can apply visual aids to facilitate identification of employee groups 119, and similarities between employee evaluations 108 for employees 104 of a particular one of employee groups 119. For example, chart filters 122 can include a color filter to more readily distinguish between the various employee groups 119.

Aggregate evaluation graph 124 is a graph showing plots of current distribution 125 for employee evaluations 108. Current distribution 125 is a distribution for employee evaluations 108 as currently entered onto the evaluation chart 120. In one illustrative example, current distribution 125 for employee evaluations 108 is indicated as a plot on aggregate evaluation graph 124. The plot can be, for example but not limited to, a bell curve.

In one embodiment, current distribution 125 is a standard distribution according to the formula:

$$f ( x , μ , σ ) = \frac{1}{σ \sqrt{2 π}} {e}^{- \frac{{( x - μ )}^{2}}{2 {σ}^{2}}} \qquad Equation 1$$

wherein:

x is an observed score based on employee evaluations 108;

μ is the mean or expectation of current distribution 125; and

σ is the standard deviation current distribution 125.

Employee evaluation system 102 recognizes that supervisor 106 may be predisposed to favor those employees 104 that are direct reports to supervisor 106 over employees 104 with which supervisor 106 has less frequent contact. For example, because of the direct relationship of supervisor 106 to employees that are direct reports, supervisor 106 may be inclined to attribute events that reflect positively on those direct reports. This natural bias is sometimes known as in-group favoritism, in-group-out-group bias, in-group bias, or intergroup bias.

Therefore, employee evaluations 108 received by evaluation system 102 from supervisor 106 are initially biased evaluations 130. Biased evaluations 130 are employee evaluations 108, for which current distribution 125 does not conform to ideal distribution 132. Current distribution 125 of biased evaluations 130 are displayed with an aggregate evaluation graph 124 as biased plot 134.

Ideal distribution 132 is an expected distribution for employee evaluations 108 as determined by employer 110. Ideal distribution 132 is not determined based on current distribution 125 of biased evaluations 130, but rather on distributions and statistics arbitrarily set by employer 110. As such, employer 110 can define ideal distribution 132 according to a desired mean and a desired standard deviation for ideal distribution 132.

Ideal distribution 132 can be defined within employee evaluation system 102 by system administrator 136. System administrator 136 is an administrator of employee evaluation system 102. In an illustrative embodiment, system administrator 136 can be one of employees 104.

In one embodiment, ideal distribution 132 is a standard normal distribution according to the formula:

$$f ( x , μ , σ ) = \frac{1}{σ \sqrt{2 π}} {e}^{- \frac{{( x - μ )}^{2}}{2 {σ}^{2}}} \qquad Equation 2$$

wherein:

x is an observed score based on employee evaluations 108;

μ is the mean or expectation of ideal distribution 132; and

σ is the standard deviation ideal distribution 132.

To facilitate identification of bias inherent in biased evaluations 130, aggregate evaluation graph 124 can also display ideal plot 138. Ideal plot 138 is a plot of ideal distribution 132. In one illustrative embodiment, ideal plot 138 can be displayed within aggregate evaluation graph 124 by overlaying ideal plot 138 with biased plot 134.

Employee evaluation system 102 can include evaluation auditor 140. Evaluation auditor 140 can determine current distribution 125 for employee evaluations 108, identify discrepancies between current distribution 125 and ideal distribution 132, and make suggestions 142.

Evaluation auditor 140 may be implemented in software, hardware, firmware or a combination thereof. When software is used, the operations performed by evaluation auditor 140 may be implemented in program code configured to run on hardware, such as a processor unit. When firmware is used, the operations performed by evaluation auditor 140 may be implemented in program code and data and stored in persistent memory to run on a processor unit. When hardware is employed, the hardware may include circuits that operate to perform the operations in evaluation auditor 140.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

According to an illustrative embodiment, for the purpose of determining current distribution 125, evaluation auditor 140 assigns a numeric score to each employee evaluations 108 based on a position within evaluation chart 120. The numeric scores can then be adjusted by applying parameter weights 129 to emphasize certain evaluation parameters 128 when determining the relative performance of employees 104.

Suggestions 142 are recommended alterations of biased evaluations 130 for one or more of the employees 104 based on discrepancies identified between current distribution 125 and ideal distribution 132. In one illustrative embodiment, evaluation auditor 140 makes suggestions 142 to recommend alterations of biased evaluations 130 for one or more of the employees 104 such that the current distribution 125 more closely approximates ideal distribution 132.

Rationalized evaluations 144 are reassessments of biased evaluations 130 by supervisor 106 such that current distribution 125 more closely approximates ideal distribution 132. In one illustrative embodiment, rationalized evaluations 144 take into account suggestions 142 made by evaluation auditor 140. Accordingly, supervisor 106 may enter rationalized evaluations 144 by simply accepting suggestions 142 to biased evaluations 130.

In an illustrative embodiment, supervisor 106 may feel particularly strong regarding employee evaluations 108 for particular ones of employees 104. Therefore, supervisor 106 may enter rationalized evaluations 144 by manually making alterations to biased evaluations 130 for one or more of the employees 104. Therefore, rationalized evaluations 144 may not necessarily strictly conform to suggestions 142. However, current distribution 125 must still conform to ideal distribution 132 within acceptable tolerances before the evaluation auditor 140 will accept employee evaluations 108 as rationalized evaluations 144.

Timeline 126 is a history of rationalized evaluations 144 for employees 104 at predetermined the evaluation times. Timeline 126 facilitates easy identification of employee growth, employee stagnation, or employee regression among employees 104 as determined from rationalized evaluations 142 for successive evaluation times.

In the illustrative example, employee evaluation system 102 may be used to evaluate employees 104 through the submission of employee evaluations 108 by supervisor 106, and auditing of employee evaluations 108 by evaluation auditor 140. By identifying discrepancies between current distribution 125 and ideal distribution 132, and recommending suggestions 142 for alterations of biased evaluations 130 for one or more of the employees 104, evaluation auditor 140 facilitates an evenhanded evaluation of employees without overemphasis on a particular characteristic, quality, or performance of employees 104.

After evaluation by evaluation auditor 140, employer 110 can use rationalized evaluations 144 to more accurately assess characteristics, qualities, or performances of employees 104. Evaluation auditor 140 facilitates this assessment by minimizing any natural bias of supervisor 106 for in-group favoritism of certain ones of employees 104.

As a result, computer system 112 operates as a special purpose computer system in which evaluation auditor 140 in computer system 112 enables more accurate assessments of the characteristics, qualities, or performances of employees 104 to be performed as part of an employee evaluation system based on rationalized evaluations 144 of employees 104. Evaluation auditor 140 determines current distribution 125 for employee evaluations 108, identifies discrepancies between current distribution 125 and ideal distribution 132, and makes suggestions 142. Evaluation auditor 140 enables a relatively unbiased evaluation of employees 104 by forcing supervisor 106 to conform current distribution 125 of employee evaluations 108 to ideal distribution 132.

Evaluation auditor 140 enables a relatively unbiased approach to employee evaluation activities to be performed as part of an employee evaluation system. Thus, evaluation auditor 140 transforms computer system 112 into a special purpose computer system as compared to currently available general computer systems that do not have evaluation auditor 140.

The illustration of employee evaluation system 102 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

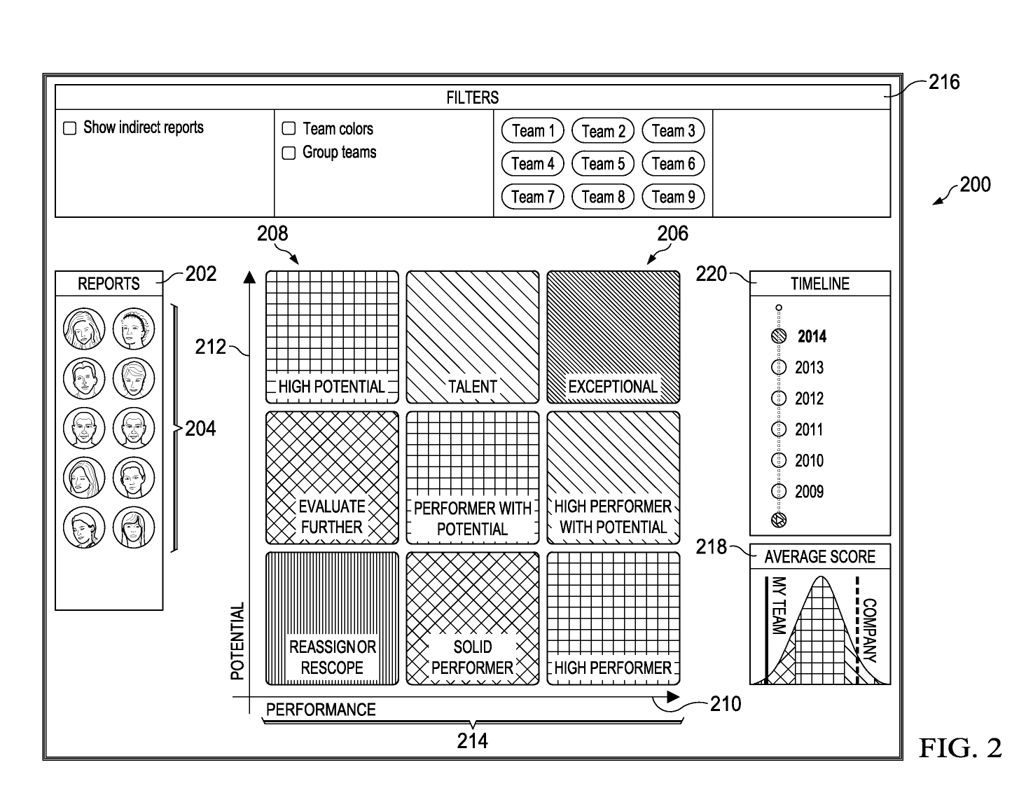

With reference next to FIG. 2, an illustration of a graphical user interface in an employee evaluation system is depicted in accordance with an illustrative embodiment. As depicted, graphical user interface 200 is an example of graphical user interface 116 in FIG. 1.

Interface 200 includes employee list 202. Employee list 202 is an example of employee list 118 of FIG. 1. As depicted, employee list 202 is a graphical indication of employees 104 in employee group 204. Employee group 204 is an example of one of employee groups 119 of FIG. 1. As depicted, employee group 204 are direct reports to a supervisor, such a supervisor 106 in FIG. 1.

Graphical user interface 200 includes evaluation chart 206. Evaluation chart 206 is an example of evaluation chart 120 of FIG. 1. As depicted, evaluation chart 206 is an interactive graphical chart through which employee evaluation system 102 can receive and display employee evaluations 108 for employee group 204. In the illustrative embodiment, evaluation chart 206 is a multi-axis grid on which supervisor 106 can enter assessments of at least one of various characteristics, qualities, or performances of employee group 204.

As depicted, evaluation chart 206 is a nine-box grid 208. Nine-box grid 208 is a graphical tool that supervisor 106 utilizes to enter employee evaluations 108 into employee evaluation system 102. Nine-box grid 208 provides a quantized measurement scale of evaluation parameters 128 plots along its axes. As depicted, evaluation parameters 128 are employee performance as plotted along axis 210, and employee potential as plotted along axis 212.

As depicted, nine box grid 208 ranks evaluation parameters 128 on a three-tiered measurement scale. As depicted, a ranking in the second tier is indicative of an average, or satisfactory, evaluation for the corresponding one of evaluation parameters 128. A ranking the first tier is indicative of a below average score, and a ranking in the third tier is indicative of an above-average score.

The three-tiered measurement scale for evaluation parameters 128 as plotted along axis 210 and axis 212 define plurality of fields 214 within nine box grid 208. Supervisor 106 enters employee evaluations 108 into employee evaluation system 102 by associating employees of employee group 204 with one of plurality of fields 214. As depicted, employees of employee group 204 can be associated with one of the plurality fields 214 when supervisor 106 places a corresponding icon into one of plurality of fields 214.

While the embodiment depicted in graphical user interface 200 shows evaluation chart 206 as nine-box grid 208, such is not intended to be limiting. For example, evaluation chart 206 may have additional axes plotting additional evaluates and parameters. Furthermore, evaluation chart 206 may have additional fields as defined by a measurement scale having more than three tiers.

Graphical user interface 200 can include chart filters 216. Chart filters 216 is an example of chart filters 122 of FIG. 1. Chart filters 216 are various view filters that can be applied to employee group 204 when displayed in evaluation chart 206.

Graphical user interface 200 can include aggregate evaluation graph 218. Aggregate evaluation graph 218 is an example of aggregate evaluation graph 124 of FIG. 1. Aggregate evaluation graph 218 is a graph showing plots of current distribution 125 for employee evaluations 108 entered into evaluation chart 206.

Graphical user interface 200 can include timeline 220. Timeline 220 is an example of timeline 126 in FIG. 1. Timeline 220 history of rationalized evaluations 144 for each of group of employees 204 at predetermined evaluation times.

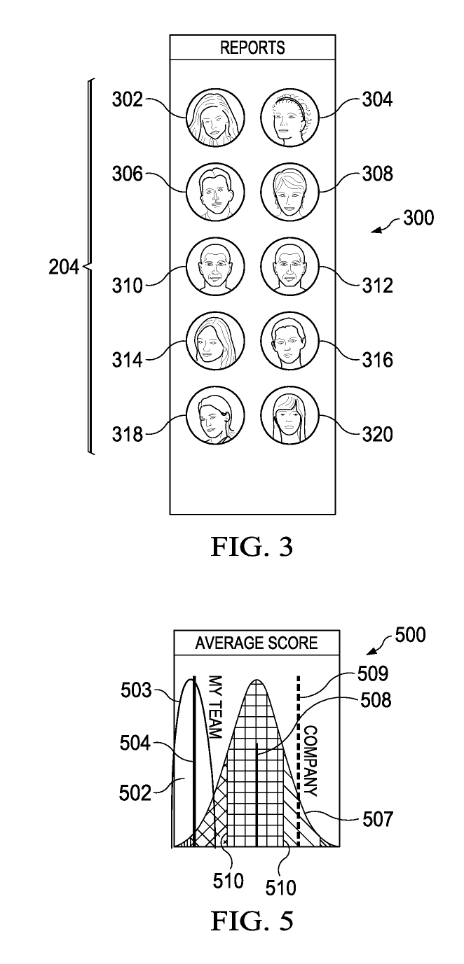

With reference next to FIG. 3, an illustration of an employee list within a graphical user interface is depicted in accordance with an illustrative embodiment. As depicted, employee list 300 is a detailed view of employee list 202 of FIG. 2.

Employee list 300 includes employee group 204. As depicted, employee group 204 includes employee 302, employee 304, employee 306, employee 308, employee 310, employee 312, employee 314, employee 316, employee 318, and employee 320.

Supervisor 106 enters employee evaluations 108 into employee evaluation system 102 by associating employees in employee group 204 with one of the plurality of fields 214. As depicted, employees in employee group 204 can be associated with one of the plurality fields 214 when supervisor 106 places employees in employee group 204 into plurality of fields 214. In an illustrative embodiment, supervisor 106 can drag employee 302, employee 304, employee 306, employee 308, employee 310, employee 312, employee 314, employee 316, employee 318, and employee 320 from employee list 300 into one of plurality of fields 214.

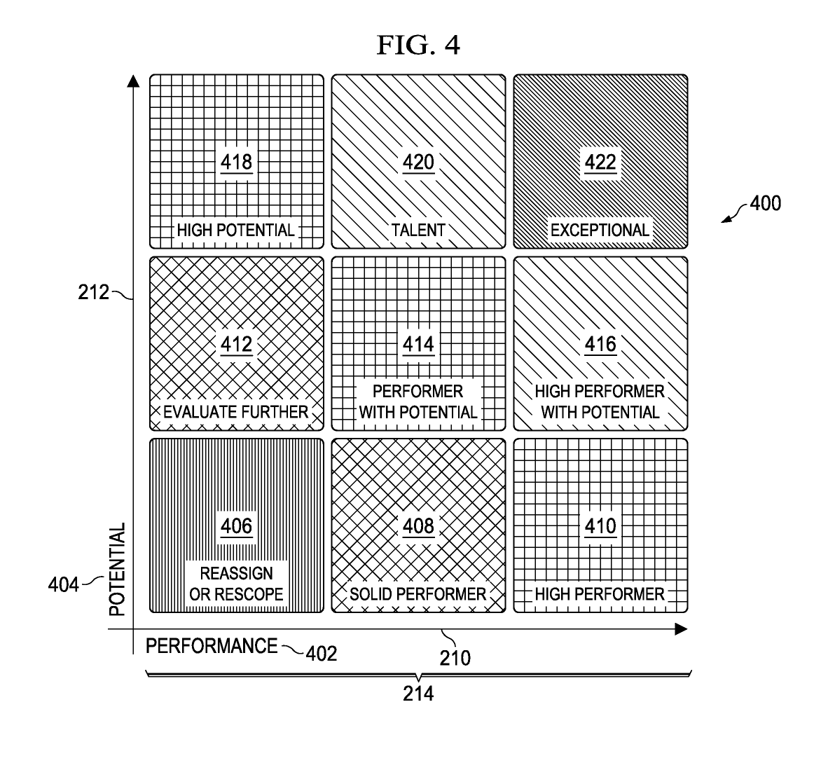

Referring now to FIG. 4, an illustration of an employee evaluation chart within a graphical user interface is depicted in accordance with an illustrative embodiment. As depicted, evaluation chart 400 is a detailed view of evaluation chart 206 of FIG. 2.

As depicted, evaluation chart 400 is a graphical tool that supervisor 106 utilizes to enter employee evaluations 108 for employee group 204 into employee evaluation system 102. As depicted, evaluation chart 400 provides a quantized measurement scale of evaluation parameters 128 plots along its axes. As depicted, evaluation parameters 128 include employee performance 402 plotted along axis 210, and employee potential 404 as plotted along axis 212.

The three-tiered measurement scale for employee performance 402 plotted along axis 210, and employee potential 404 as plotted along axis 212 define plurality of fields 214. Each of plurality of fields 214 is a field within evaluation chart 400 corresponding to a particular combination of evaluation parameters 128 rankings on the three-tiered measurement scale. As depicted, the plurality of fields 214 includes field 406, field 408, field 410, field 412, field 414, field 416, field 418, field 420, and field 422.

As depicted, field 406 is labeled “reassign or re-scope.” Field 406 corresponds to a below average evaluation of employee performance 402 and a below average evaluation of employee potential 404. An employee evaluations 108 within field 406 indicates to employee evaluation system 102 that the employee consistently underperforms expectations, as indicated by employee performance 402 plotted along axis 210. Furthermore, supervisor 106 does not believe the employee capable of succeeding at different or expanded responsibilities, as indicated by employee potential 404 plotted along axis 212.

As depicted, field 408 is labeled “solid performer.” Field 408 corresponds to an average evaluation of employee performance 402 and a below average evaluation of employee potential 404. Employee evaluations 108 within field 408 indicates to employee evaluation system 102 that the employee consistently performs up to expectations, as indicated by employee performance 402 plotted along axis 210. However, supervisor 106 does not believe the employee capable of succeeding at different or expanded responsibilities, as indicated by employee potential 404 plotted along axis 212.

As depicted, field 410 is labeled “high performer.” Field 410 corresponds to an above average evaluation of employee performance 402 and a below average evaluation of employee potential 404. An employee evaluations 108 within field 410 indicates to employee evaluation system 102 that the employee consistently surpasses expectations, as indicated by employee performance 402 plotted along axis 210. However, supervisor 106 does not believe the employee capable of succeeding at different or expanded responsibilities, as indicated by employee potential 404 plotted along axis 212.

As depicted, field 412 is labeled “evaluate further.” Field 412 corresponds to a below average evaluation of employee performance 402 and an average evaluation of employee potential 404. An employee evaluations 108 within field 412 indicates to employee evaluation system 102 that the employee consistently underperforms expectations, as indicated by employee performance 402 plotted along axis 210. However, supervisor 106 believes the employee may be capable of succeeding at different or expanded responsibilities, as indicated by employee potential 404 plotted along axis 212.

As depicted, field 414 is labeled “performer with potential.” Field 414 corresponds to an average evaluation of employee performance 402 and an average evaluation of employee potential 404. An employee evaluations 108 within field 414 indicates to employee evaluation system 102 that the employee consistently performs up to expectations, as indicated by employee performance 402 plotted along axis 210. Additionally, supervisor 106 believes the employee may be capable of succeeding at different or expanded responsibilities, as indicated by employee potential 404 plotted along axis 212.

As depicted, field 416 is labeled “high performer with potential.” Field 416 corresponds to an above average evaluation of employee performance 402 and an average evaluation of employee potential 404. An employee evaluations 108 within field 416 indicates to employee evaluation system 102 that the employee consistently surpasses expectations, as indicated by employee performance 402 plotted along axis 210. Additionally, supervisor 106 believes the employee may be capable of succeeding at different or expanded responsibilities, as indicated by employee potential 404 plotted along axis 212.

As depicted, field 418 is labeled “high potential.” Field 418 corresponds to a below average evaluation of employee performance 402 and an above average evaluation of employee potential 404. An employee evaluations 108 within field 418 indicates to employee evaluation system 102 that the employee consistently underperforms expectations, as indicated by employee performance 402 plotted along axis 210. However, supervisor 106 believes the employee capable of excelling at different or expanded responsibilities, as indicated by employee potential 404 plotted along axis 212.

As depicted, field 420 is labeled “talent.” Field 420 corresponds to an average evaluation of employee performance 402 and an above average evaluation of employee potential 404. An employee evaluations 108 within field 420 indicates to employee evaluation system 102 that the employee consistently performs up to expectations, as indicated by employee performance 402 plotted along axis 210. Additionally, supervisor 106 believes the employee capable of excelling at different or expanded responsibilities, as indicated by employee potential evaluation chart 400 plotted along axis 212.

As depicted, field 422 is labeled “exceptional.” Field 422 corresponds to an above average evaluation of employee performance evaluation chart 400 and an above average evaluation of employee potential 404. An employee evaluations 108 within field 422 indicates to employee evaluation system 102 that the employee consistently surpasses expectations, as indicated by employee performance 402 plotted along axis 210. Additionally, supervisor 106 believes the employee capable of excelling at different or expanded responsibilities, as indicated by employee potential 404 plotted along axis 212.

Supervisor 106 enters employee evaluations 108 into employee evaluation system 102 by associating employees in employee group 204 with one of the plurality of fields 214. As depicted, employees in employee group 204 can be associated with one of the plurality fields 214 when supervisor 106 places employees in employee group 204 into plurality of fields 214. In an illustrative embodiment, supervisor 106 can drag employee 302, employee 304, employee 306, employee 308, employee 310, employee 312, employee 314, employee 316, employee 318, and employee 320 from employee list 300 into one of field 406, field 408, field 410, field 412, field 414, field 416, field 418, field 420, and field 422.

According to an illustrative embodiment, for the purpose of determining current distribution 125, evaluation auditor 140 assigns a numeric score to each of the plurality of fields 214. The numeric scores can then be adjusted by applying parameter weights 129 to emphasize certain evaluation parameters 128 when determining the relative performance of employees 104.

As depicted, employee performance 402 and employee performance 404 are weighted equally by parameter weights 129 for the purpose of determining distribution 125. Therefore, a lowest numeric score is assigned to field 406, with the highest numeric score being assigned to field 422. Field 410, field 414, and field 418 are each assigned an identical median numeric score. Field 416 and field 420 are assigned a numeric score greater than the score of Field 410, field 414, and field 418, but less than the score of field 422. Field 408 and field 412 are assigned a numeric score greater than the score of field 422, but less than the score of Field 410, field 414, and field 418.

With reference next to FIG. 5, an illustration of an aggregate evaluation graph within a graphical user interface is depicted in accordance with an illustrative embodiment. As depicted, aggregate evaluation graph 500 is a detailed view of aggregate evaluation graph 218 of FIG. 2.

As depicted, aggregate evaluation graph 500 includes biased plot 502. Biased plot 502 is an example of biased plot 134 in FIG. 1. As depicted, biased plot 502 is a graphical depiction of the distribution 125 of scores for employee evaluations 108 for employee group 204 as entered into evaluation chart 206. As depicted, biased plot 502 comprises biased probability curve 503 and biased mean 504. Biased probability curve 503 is a graphical depiction of a probability density function (PDF) derived from employee evaluations 108 for employee group 204 as entered into evaluation chart 206. Biased mean 504 is a graphical depiction of the mean of employee evaluations 108 for employee group 204 as entered into evaluation chart 206.

As depicted, aggregate evaluation graph 500 includes ideal plot 506. Ideal plot 506 is an example of ideal plot 138 in FIG. 1. As depicted, ideal plot 506 can include a graphical depiction of ideal distribution 132 of employee evaluations 108 for employee group 204. As depicted, ideal plot 506 comprises ideal probability curve 507 and ideal mean 508. Ideal probability curve 507 is a graphical depiction of a probability density function (PDF′) describing ideal distribution 132 for employee evaluations 108 for employee group 204. Ideal mean 508 is a graphical depiction of an ideal mean for employee evaluations 108 for employee group 204. In the illustrative embodiment, ideal mean 508 can be, for example, a score for employee evaluations 108 associated with field 414. Ideal plot 506 can also include employer mean 509. Employer mean 509 is a graphical depiction of the mean score of employee evaluations 108 for all employees 104.

Based on discrepancies identified between current distribution 125 and ideal distribution 132 as indicated in biased plot 502 and ideal plot 506, evaluation auditor 140 can determine suggestions 142. In one illustrative embodiment, evaluation auditor 140 makes suggestions 142 such that distribution 125 as indicated in biased plot 502 more closely approximates ideal distribution 132 as indicated by ideal plot 506.

As depicted, aggregate evaluation graph 500 includes acceptable tolerances 510. Acceptable tolerances 510 are amounts by which distribution 125 is allowed to deviate from ideal distribution 132. Acceptable tolerances 510 can be determined based on ideal distribution 132. In an illustrative embodiment, acceptable tolerances 510 can be set at one standard deviation of ideal distribution 132, or a fraction thereof. As depicted, acceptable tolerances 510 is one standard deviation of ideal distribution 132.

In one illustrative embodiment, evaluation auditor 140 makes suggestions 142 such that biased mean 504 more closely approximates ideal mean 508. Evaluation auditor 140 may identify discrepancies between distribution 125 and ideal distribution 132 based on a difference between biased mean 504 and ideal mean 508. Specifically, evaluation auditor 140 may make suggestions 142 such that biased mean 504 more closely approximates ideal mean 508, within acceptable tolerances 510.

In one illustrative embodiment, evaluation auditor 140 makes suggestions 142 such the shape of biased probability curve 503 more closely approximates the shape of ideal probability curve 507. Evaluation auditor 140 may identify discrepancies between distribution 125 and ideal distribution 132 based on at least one of an integral of biased probability curve 503, a derivative of probability curve 503, and integral of ideal probability curve 507, and a derivative of ideal probability curve 507. Specifically, evaluation auditor 140 may make suggestions 142 such that an integral of biased probability curve 503 more closely approximates an integral of ideal probability curve 507, within acceptable tolerances 510. Similarly, evaluation auditor 140 may make suggestions 142 such that a derivative of biased probability curve 503 more closely approximates a derivative of ideal probability curve 507, within acceptable tolerances 510.

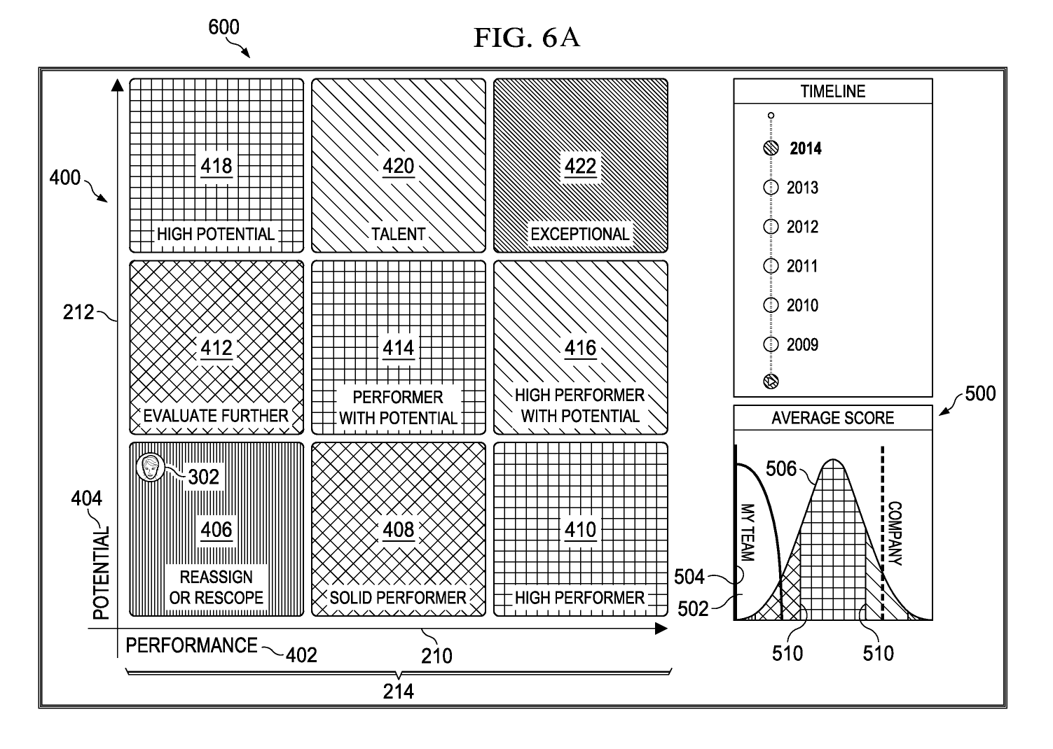

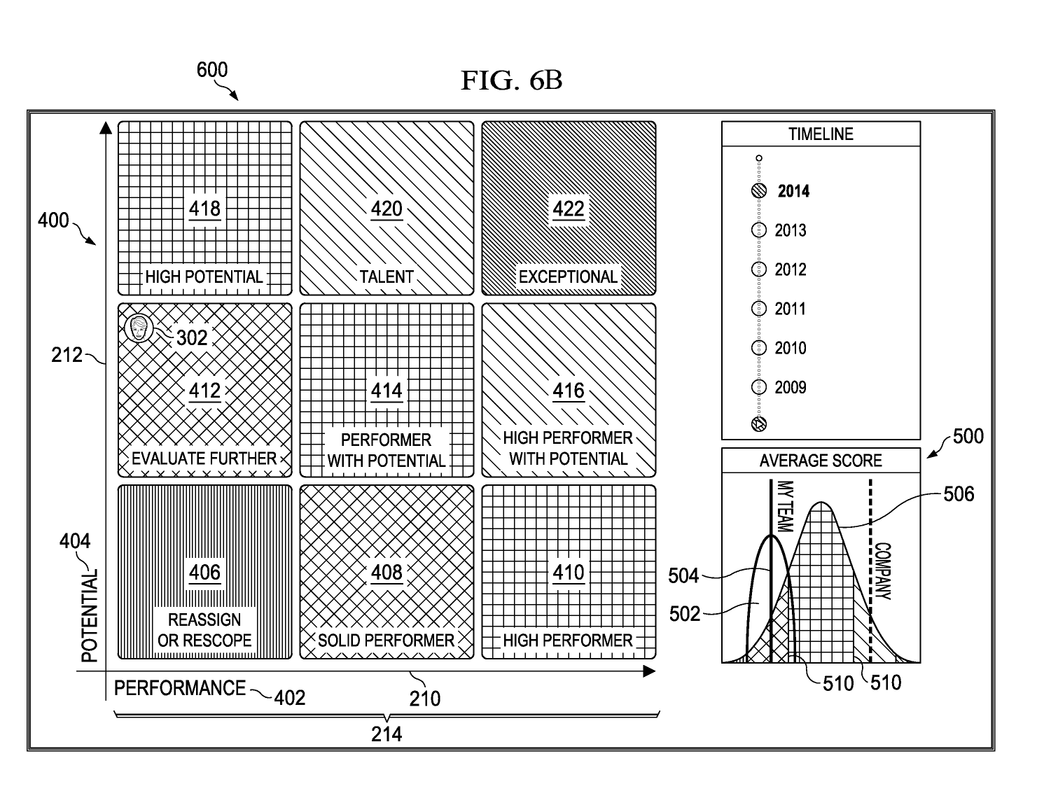

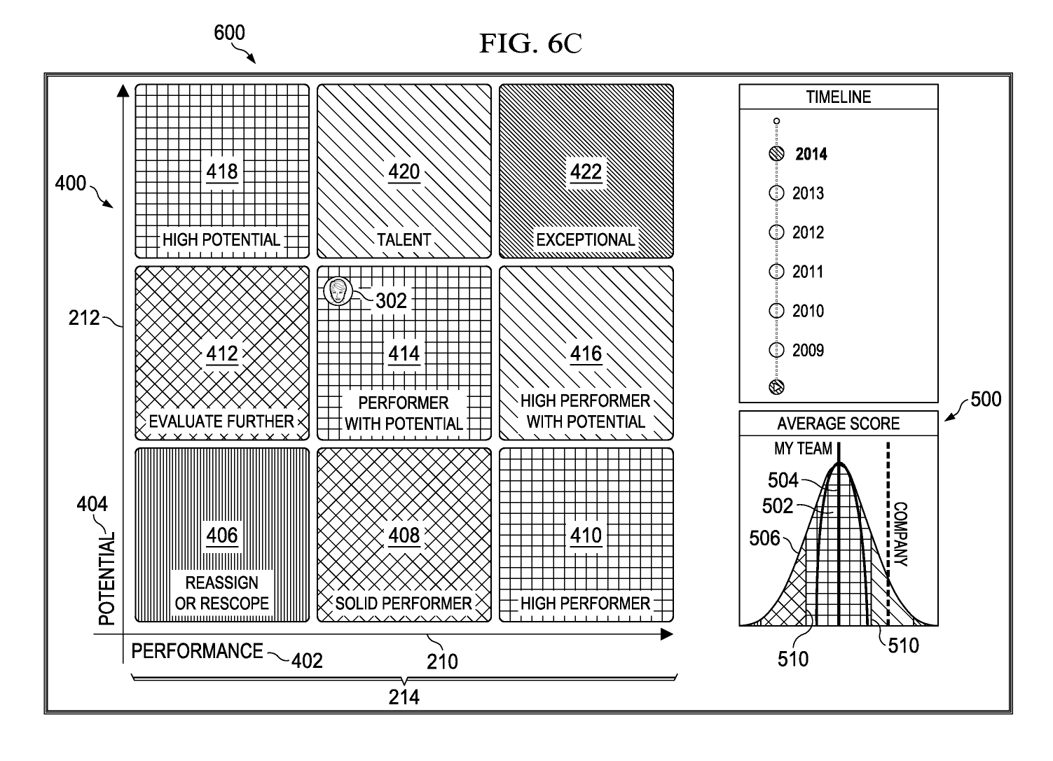

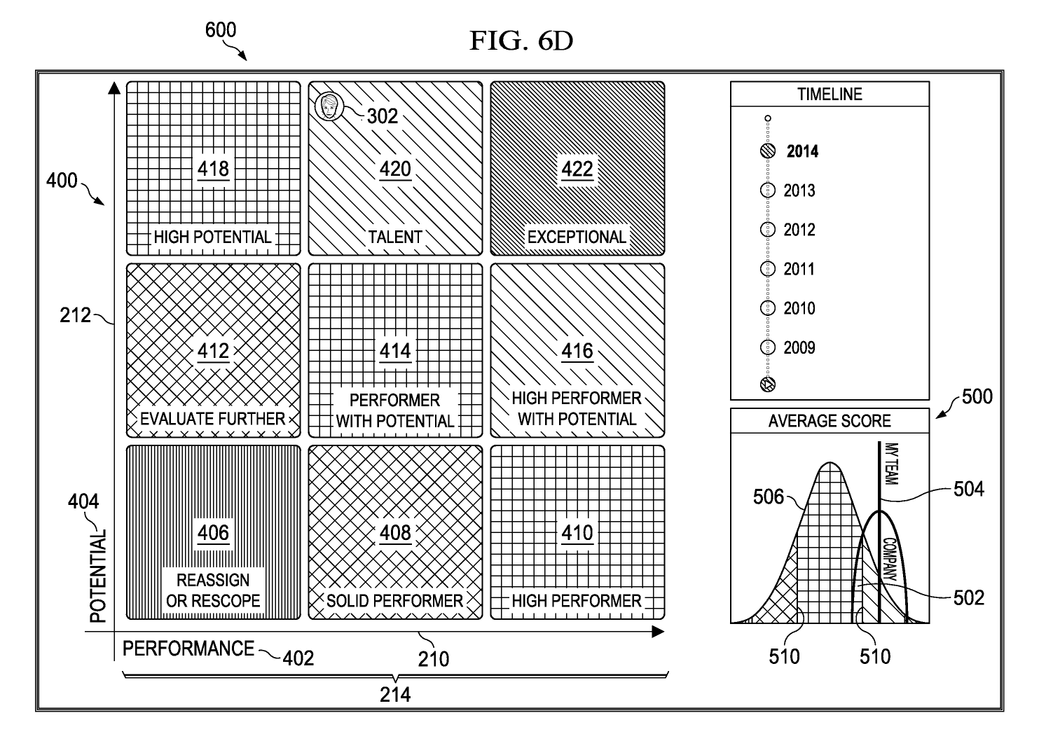

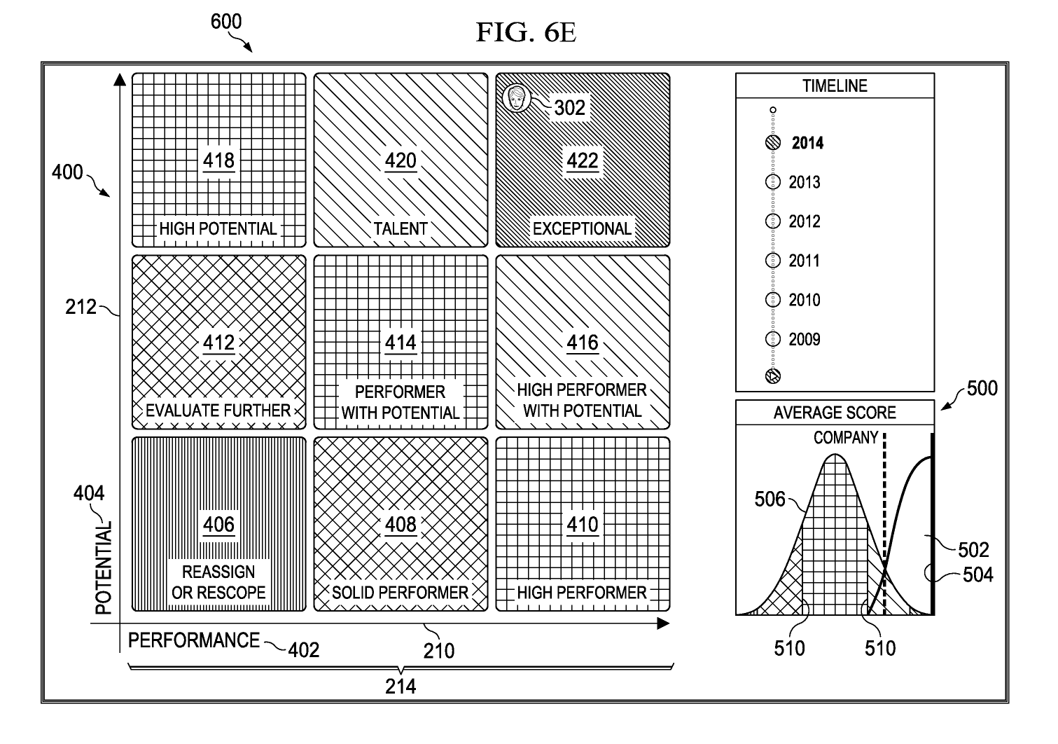

With reference next to FIGS. 6A, 6B, 6C, 6D, and 6E, an illustration of an interactive relationship between an evaluation chart and an aggregate evaluation graph for a single employee within a graphical user interface is depicted in accordance with an illustrative embodiment. As depicted, graphical user interface 600 is an example of a graphical user interface 200 of FIG. 2. Specifically, graphical user interface 600 is an illustration of an interactive relationship between evaluation chart 400 of FIG. 4 and aggregate evaluation graph 500 of FIG. 5 for employee 302 of FIG. 3.

Referring specifically to FIG. 6A, evaluation chart 400 depicts employee 302 in field 406. Employee evaluations 108 for employee 302 indicates a below average evaluation of employee performance 402 and a below average evaluation of employee potential 404. Based on employee evaluations 108 for employee 302, aggregate evaluation graph 500 determines biased plot 502 of the distribution 125 of employee evaluations 108 as entered into evaluation chart 400.

As depicted, biased mean 504 is outside acceptable tolerances 510. Evaluation auditor 140 may therefore make suggestions 142 for employee 302 based on discrepancies identified between distribution 125 as depicted in biased plot 502 and ideal distribution 132 as depicted in ideal plot 506. In one illustrative embodiment, evaluation auditor 140 suggests alterations to employee evaluations 108 employee 302 such that distribution 125 more closely approximates ideal distribution 132.

Referring specifically to FIG. 6B, evaluation chart 400 depicts employee 302 in field 412. Employee evaluations 108 for employee 302 indicates a below average evaluation of employee performance 402 and an average evaluation of employee potential 404. Based on employee evaluations 108 for employee 302, aggregate evaluation graph 500 determines biased plot 502 of the distribution 125 of employee evaluations 108 as entered into evaluation chart 400.

As depicted, employee performance 402 and employee potential 404 are weighted equally by parameter weights 129 for the purpose of determining distribution 125 as shown in biased plot 502. Therefore, an employee (not shown) depicted in field 408 would result in an identical biased plot 502 as does employee 302 depicted in field 412.

As depicted, biased mean 504 is outside acceptable tolerances 510. Evaluation auditor 140 may therefore make suggestions 140 for employee 302 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that distribution 125 more closely approximates ideal distribution 132.

Referring specifically to FIG. 6C, evaluation chart 400 depicts employee 302 in field 414. Employee evaluations 108 for employee 302 indicates an average evaluation of employee performance 402 and an average evaluation of employee potential 404. Based on employee evaluations 108 for employee 302, aggregate evaluation graph 500 determines biased plot 502 of the distribution 125 of employee evaluations 108 as entered into evaluation chart 400.

As depicted, employee performance 402 and employee potential 404 are weighted equally by parameter weights 129 for the purpose of determining distribution 125 as shown in biased plot 502. Therefore, an employee (not shown) depicted in field 410 and field 418 would result in an identical biased plot 502 in session for employee 302 depicted in field 414.

As depicted, biased mean 504 is within acceptable tolerances 510. Evaluation auditor 140 may therefore accept distribution 125 as shown in biased plot 502. Employee evaluation system 102 can simply records biased evaluations 124 as rationalized evaluation 144 without suggesting alterations to employee evaluations 108 of employee 302.

Referring specifically to FIG. 6D, evaluation chart 400 depicts employee 302 in field 420. Employee evaluations 108 for employee 302 indicates an average evaluation of employee performance 402 and an above average evaluation of employee potential 404. Based on employee evaluations 108 for employee 302, aggregate evaluation graph 500 determines biased plot 502 of the distribution 125 of employee evaluations 108 as entered into evaluation chart 400.

As depicted, employee performance 402 and employee potential 404 are weighted equally by parameter weights 129 for the purpose of determining distribution 125 as shown in biased plot 502. Therefore, an employee (not shown) depicted in field 416 would result in an identical biased plot 502 in session for employee 302 depicted in field 420.

As depicted, biased mean 504 is outside acceptable tolerances 510. Evaluation auditor 140 may therefore make suggestions 140 for employee 302 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that distribution 125 more closely approximates ideal distribution 132.

Referring specifically to FIG. 6E, evaluation chart 400 depicts employee 302 in field 422. Employee evaluations 108 for employee 302 indicates an above average evaluation of employee performance 402 and an above average evaluation of employee potential 404. Based on employee evaluations 108 for employee 302, aggregate evaluation graph 500 determines biased plot 502 of the distribution 125 of employee evaluations 108 as entered into evaluation chart 400.

As depicted, biased mean 504 is outside acceptable tolerances 510. Evaluation auditor 140 may therefore make suggestions 140 for employee 302 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that distribution 125 more closely approximates ideal distribution 132.

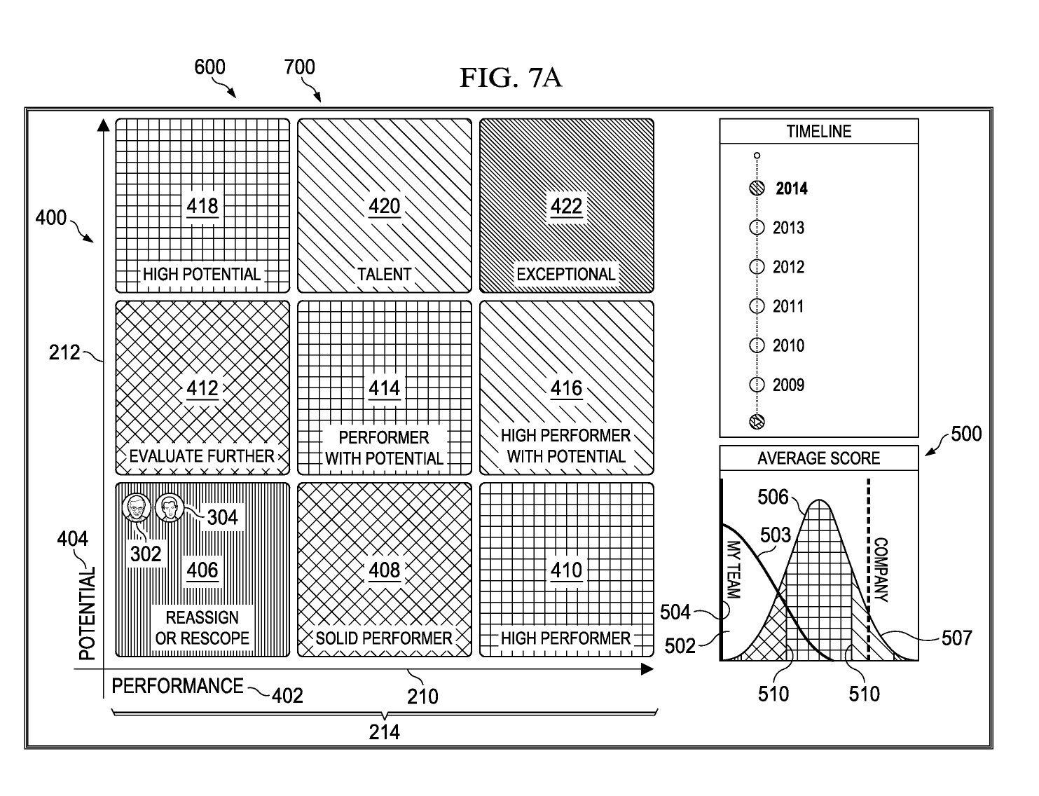

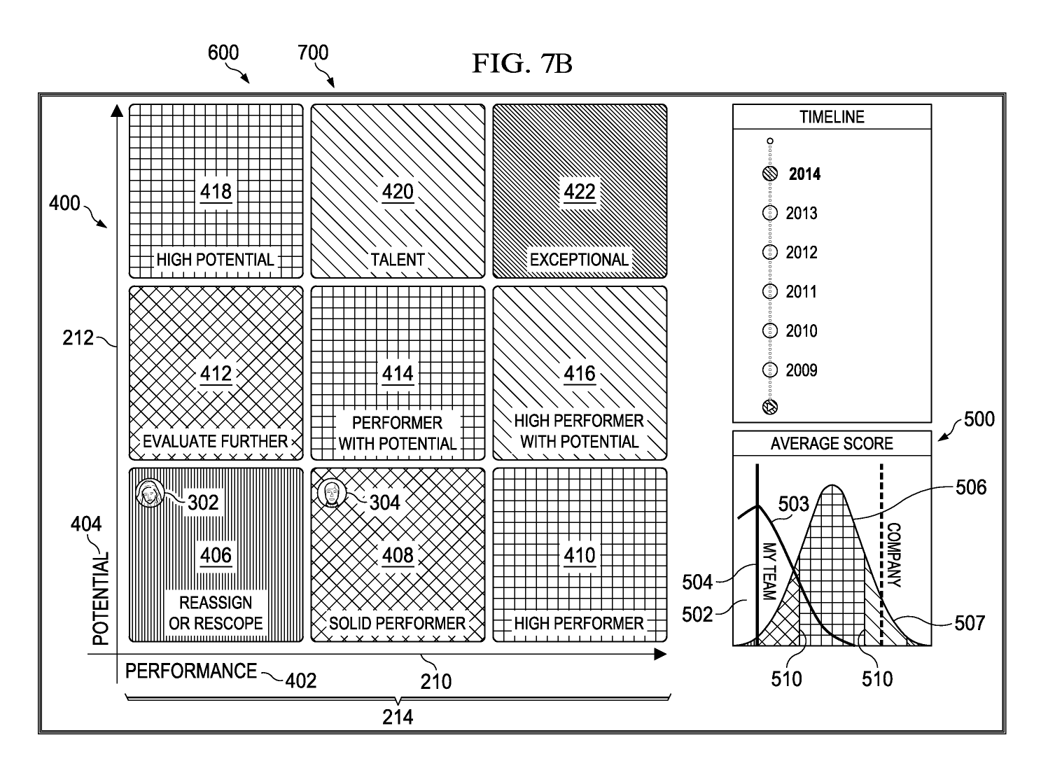

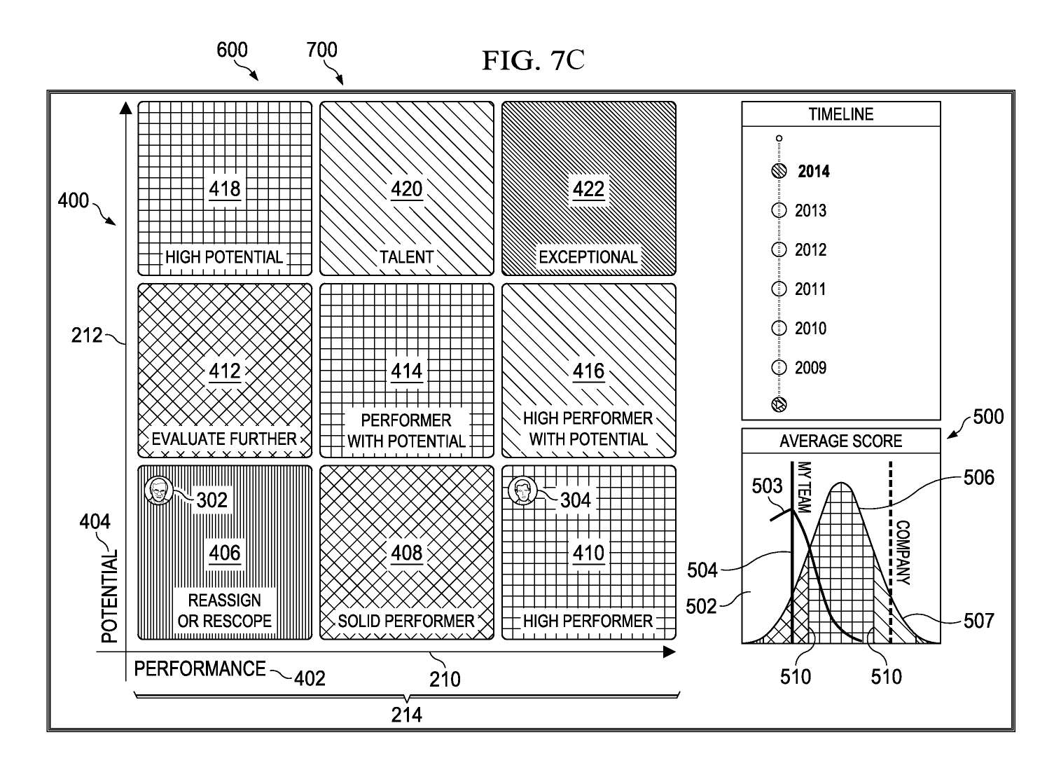

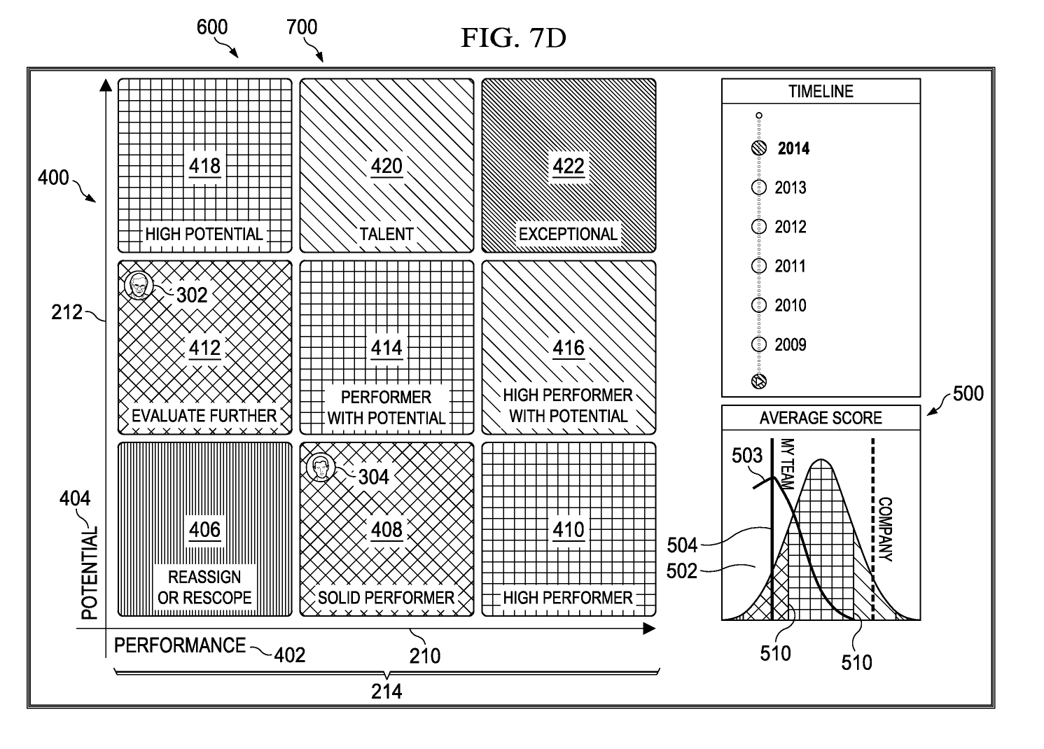

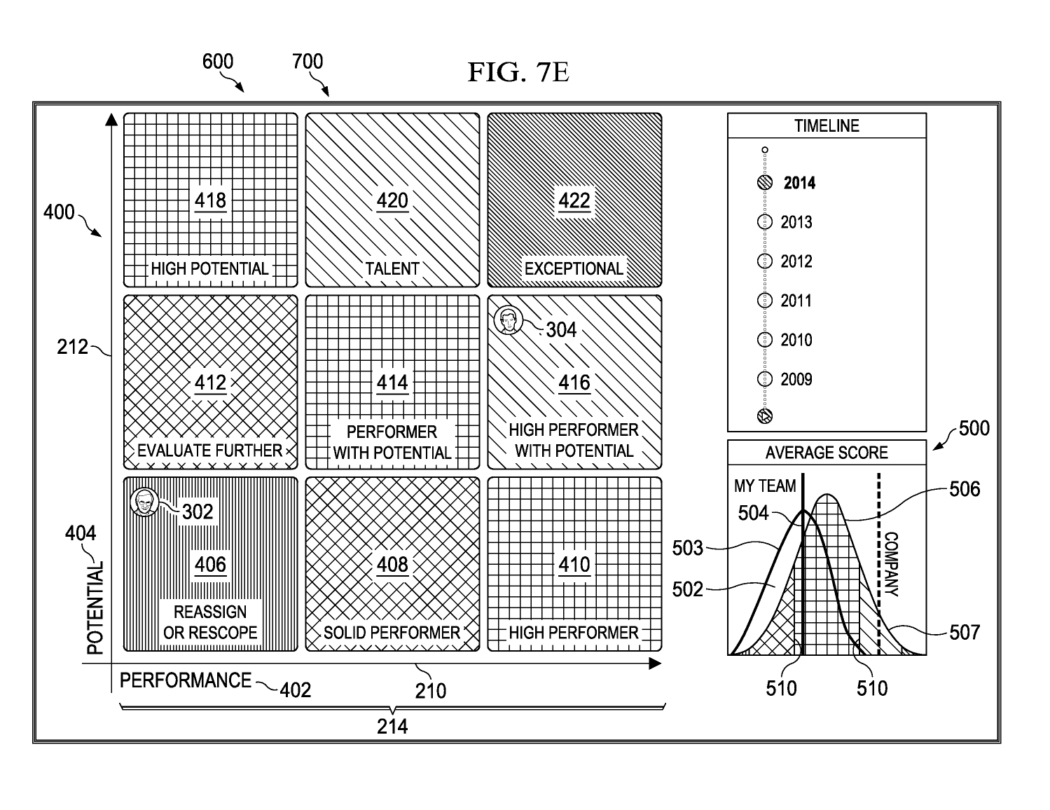

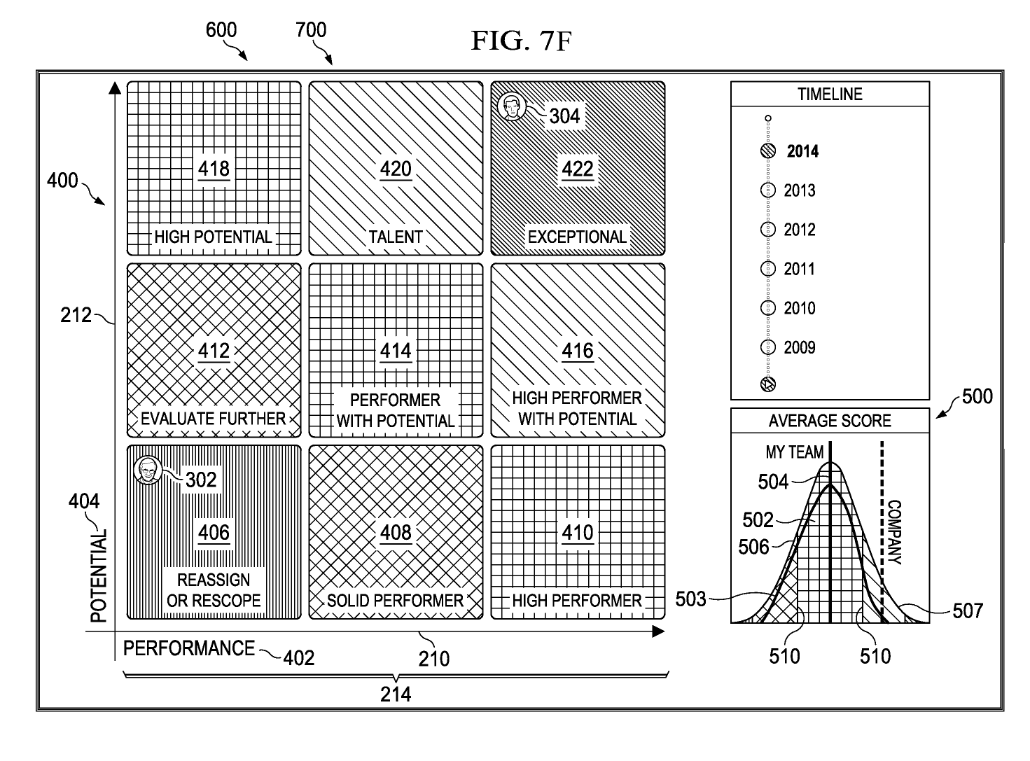

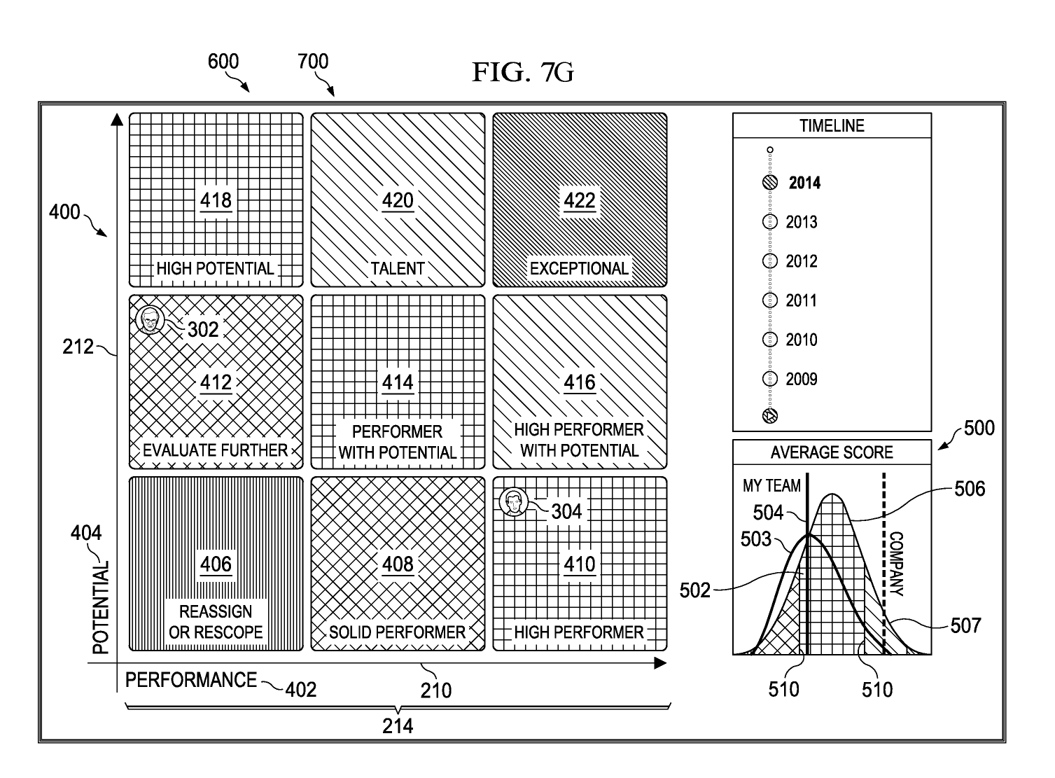

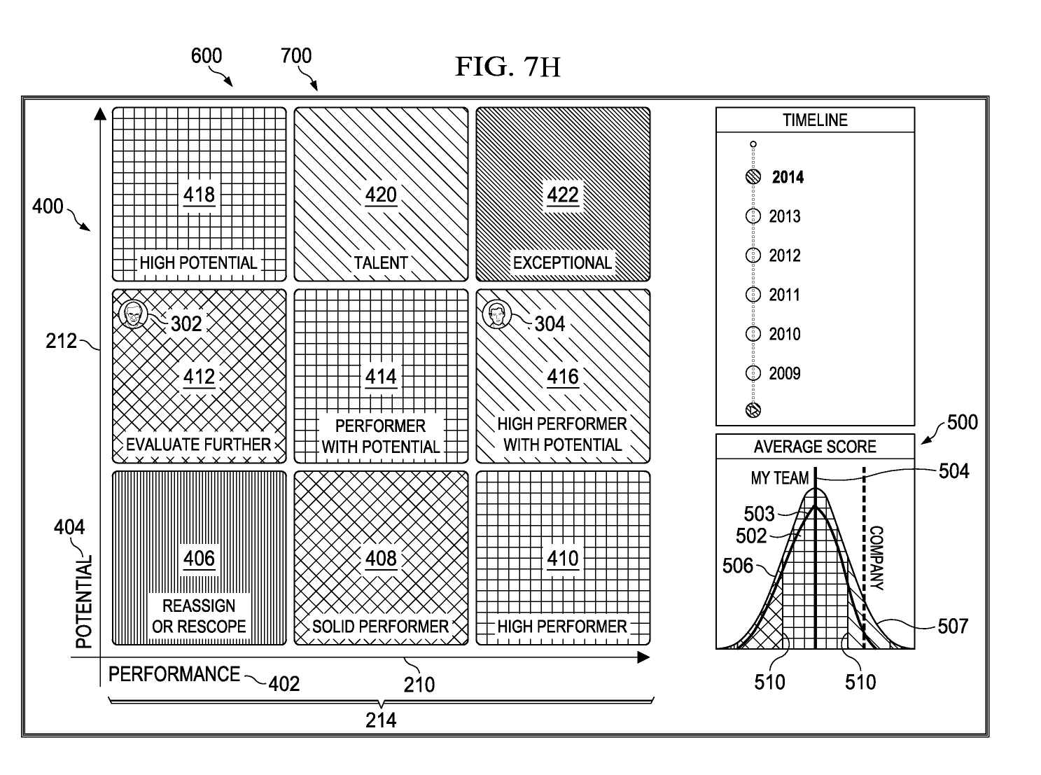

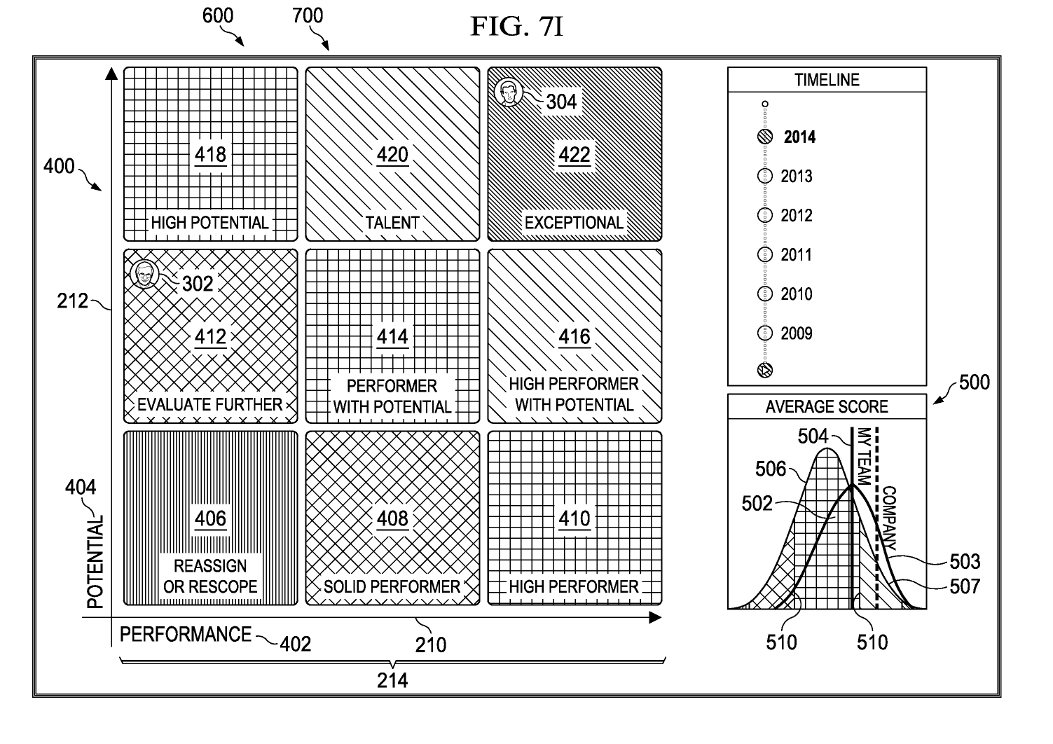

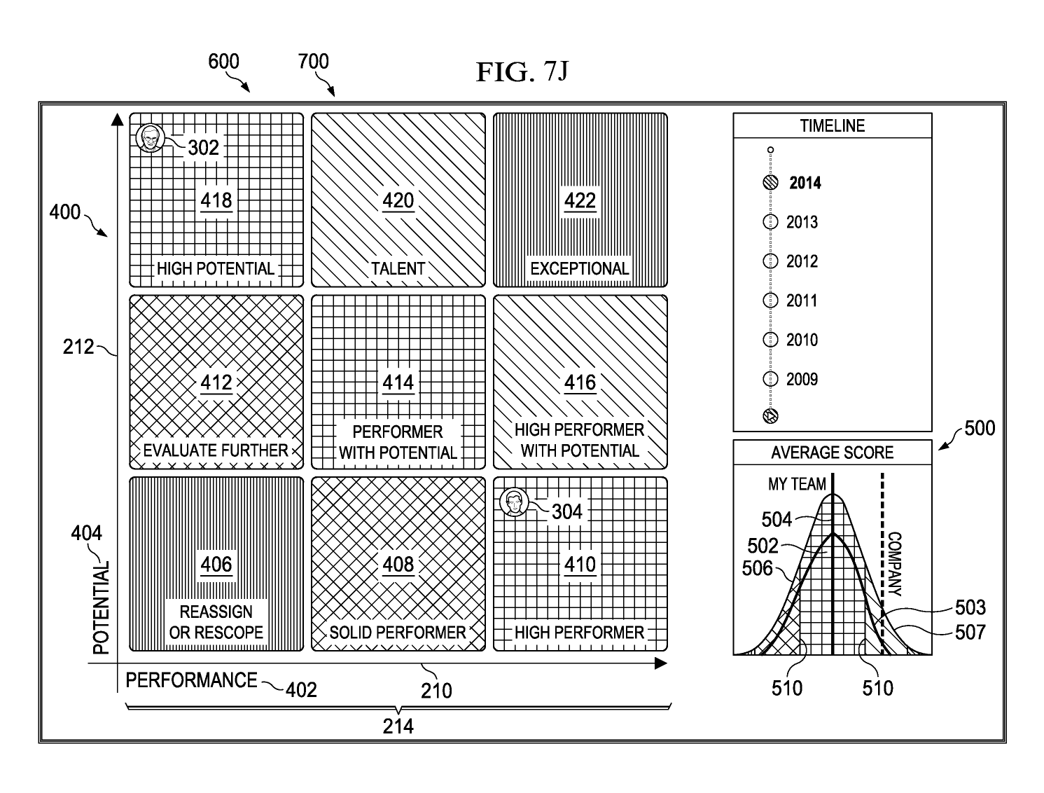

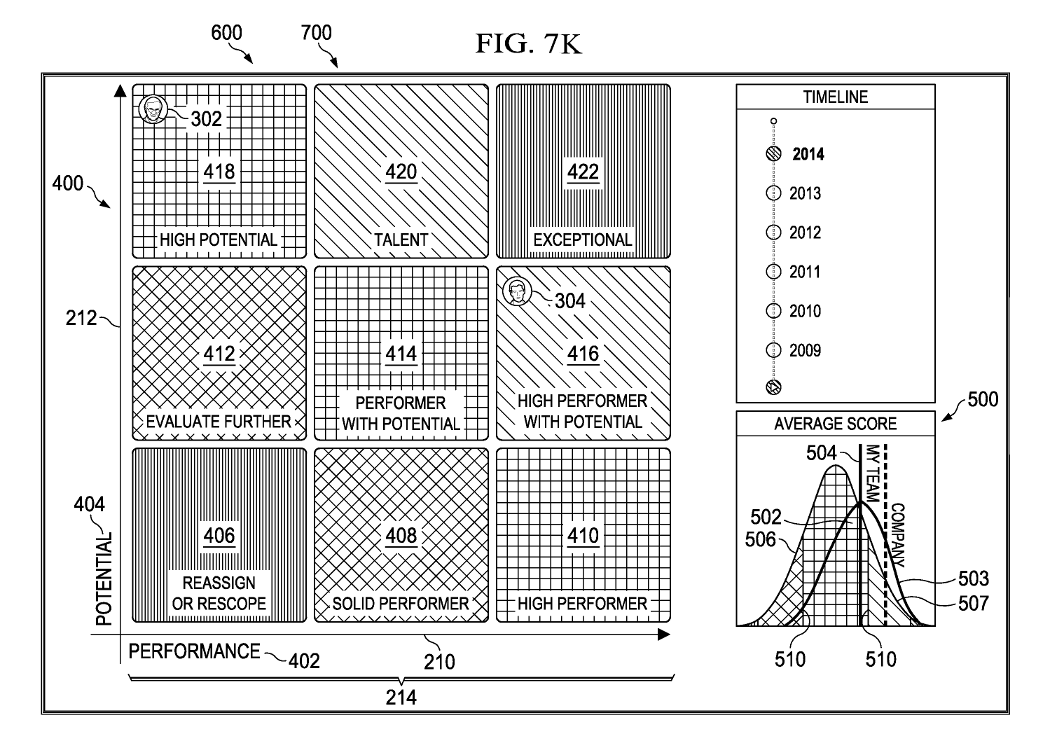

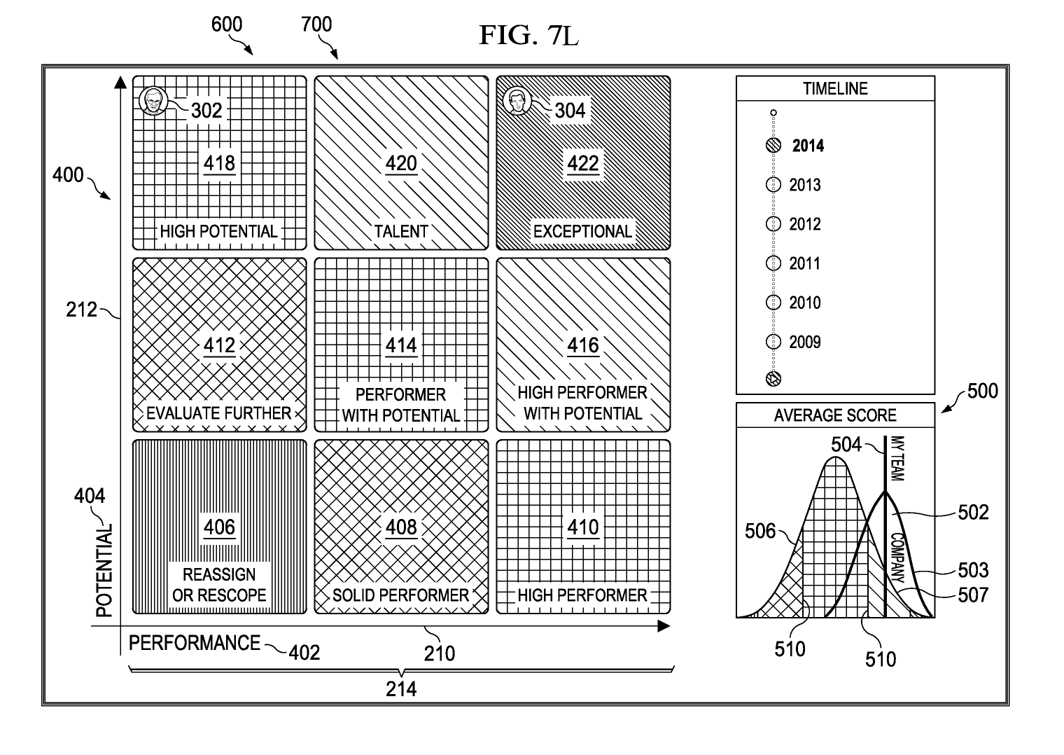

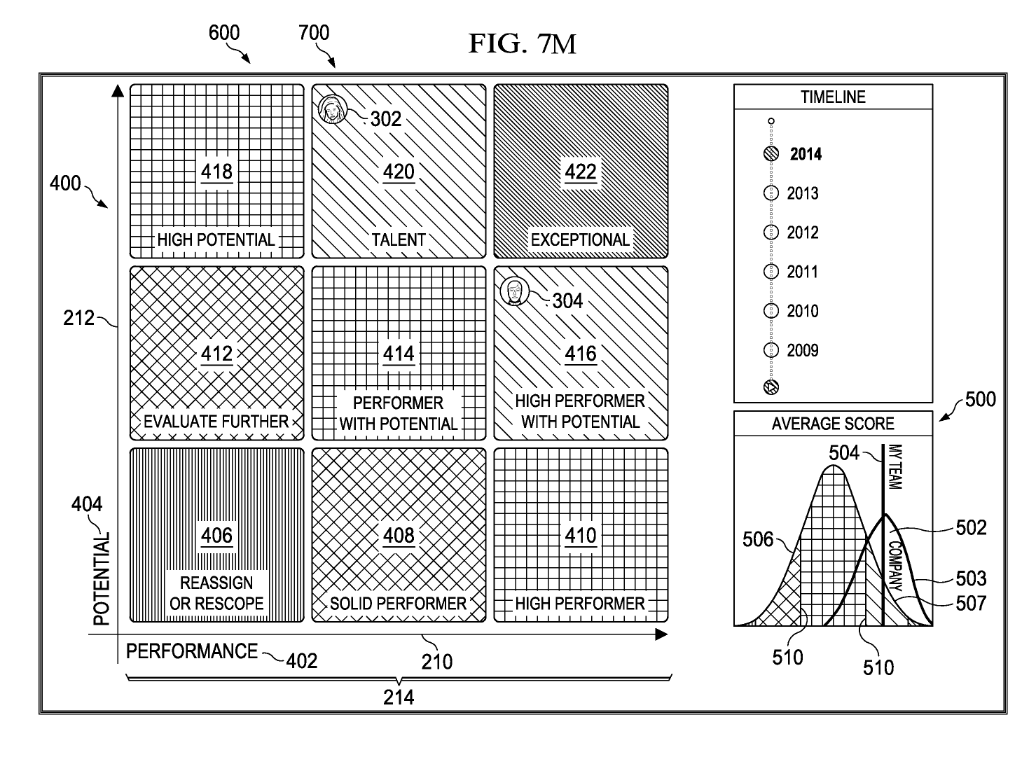

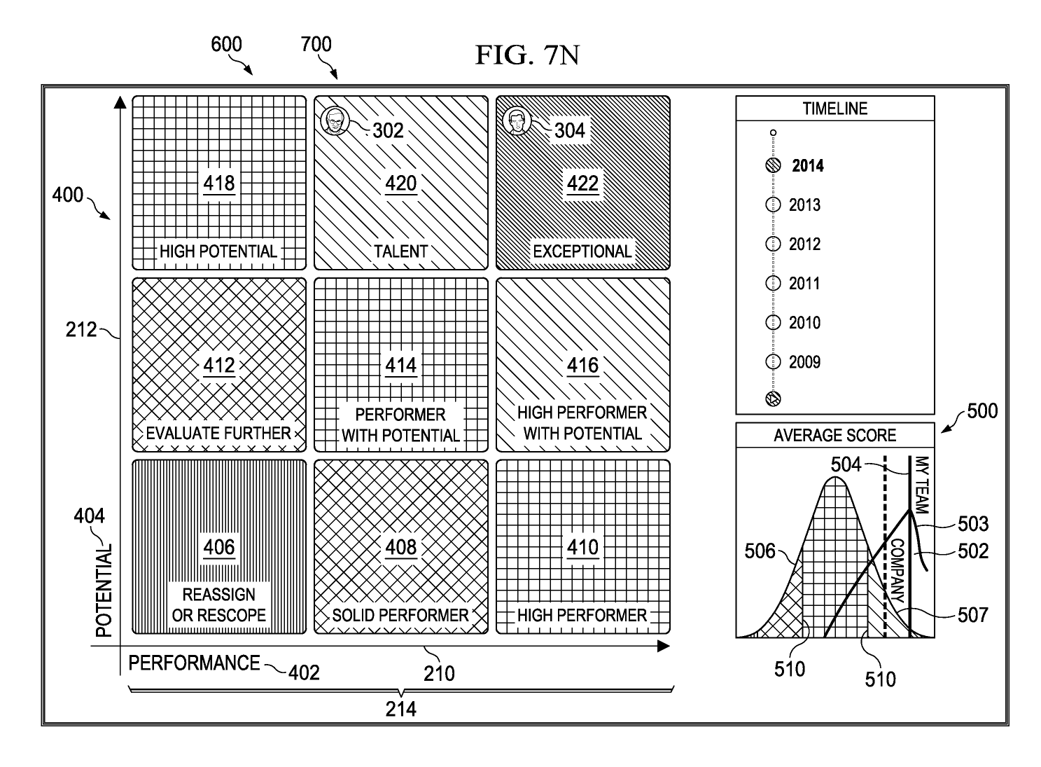

With reference next to FIGS. 7A, 7B, 7C, 7D, 7E, 7F, 7G, 7H, 7I, 7J, 7K, 7L, 7M, 7N, and 70, an illustration of an interactive relationship between an evaluation chart and an aggregate evaluation graph for two employees within a graphical user interface is depicted in accordance with an illustrative embodiment. As depicted, graphical user interface 700 is an example of graphical user interface 200 in FIG. 2.

Referring specifically to FIGS. 7A, 7B, 7C, and 7D, evaluation chart 400 is shown depicting biased mean 504 below acceptable tolerances 510. FIG. 7A depicts employee 302 and employee 304 in field 406. FIG. 7B depicts employee 302 and in field 406, and employee 304 in field 408. FIG. 7C depicts employee 302 in field 406, and employee 304 in field 410. FIG. 7D depicts employee 302 in field 412, and employee 304 in field 408.

Based on employee evaluations 108 for employee 302 and employee 304, aggregate evaluation graph 500 determines biased plot 502 of the distribution 125 of employee evaluations 108 as entered into evaluation chart 400. Biased plot 502 displays biased probability curve 503 and biased mean 504.

As depicted, biased mean 504 is below acceptable tolerances 510. Evaluation auditor 140 may therefore suggest suggestions 140 for at least one of employee 302 and employee 304 based on discrepancies identified between distribution 125 as shown in biased plot 502 and ideal distribution 132 as shown in ideal plot 506. In one illustrative embodiment, evaluation auditor 140 suggests alterations to employee evaluations 108 of for at least one of employee 302 and employee 304 such that distribution 125 as shown in biased plot 502 more closely approximates ideal distribution 132 as shown in ideal plot 506.

Referring specifically to FIGS. 7E, 7F, 7G, 7H, 7I, 7J, and 7K, evaluation chart 400 is shown depicting biased mean 504 within acceptable tolerances 510. FIG. 7E depicts employee 302 in field 406, and employee 304 in field 416. FIG. 7F depicts employee 302 in field 406, and employee 304 in field 422. FIG. 7G depicts employee 302 in field 412, and employee 304 in field 410. FIG. 7H depicts employee 302 in field 412, and employee 304 in field 416. FIG. 7I depicts employee 302 in field 412, and employee 304 in field 422. FIG. 7J depicts employee 302 in field 418, and employee 304 in field 410. FIG. 7K depicts employee 302 in field 418, and employee 304 in field 416.

Based on employee evaluations 108 for employee 302 and employee 304, aggregate evaluation graph 500 determines biased plot 502 of the distribution 125 of employee evaluations 108 as entered into evaluation chart 400. Biased plot 502 displays biased probability curve 503 and biased mean 504.

As depicted, biased mean 504 is within acceptable tolerances 510. Evaluation auditor 140 may therefore accept distribution 125 as shown in biased plot 502. Employee evaluation system 102 can simply records biased evaluation 124 as rationalized evaluation 142 without suggesting alterations to distribution 125, as shown in biased plot 502, of employee evaluations 108.

Alternatively, evaluation auditor 140 may suggest suggestions 140 for at least one of employee 302 and employee 304 based on discrepancies identified between distribution 125 as shown in biased plot 502 and ideal distribution 132 as shown in ideal plot 506. In one illustrative embodiment, evaluation auditor 140 suggests alterations to employee evaluations 108 for at least one of employee 302 and employee 304 such that the shape of biased probability curve 503 more closely approximates the shape of ideal probability curve 507.

Referring specifically to FIGS. 7L, 7M, 7N, and 70, evaluation chart 400 is shown depicting biased mean 504 above acceptable tolerances 510. FIG. 7L depicts employee 302 and in field 418, and employee 304 in field 422. FIG. 7M depicts employee 302 in field 420, and employee 304 in field 416. FIG. 7N depicts employee 302 in field 420, and employee 304 in field 422. FIG. 7O depicts employee 302 and employee 304 in field 422.

Based on employee evaluations 108 for employee 302 and employee 304, aggregate evaluation graph 500 determines biased plot 502 of the distribution 125 of employee evaluations 108 as entered into evaluation chart 400. Biased plot 502 displays biased probability curve 503 and biased mean 504.

As depicted, biased mean 504 is above acceptable tolerances 510. Evaluation auditor 140 may therefore suggest suggestions 140 for at least one of employee 302 and employee 304 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that distribution 125 more closely approximates ideal distribution 132.

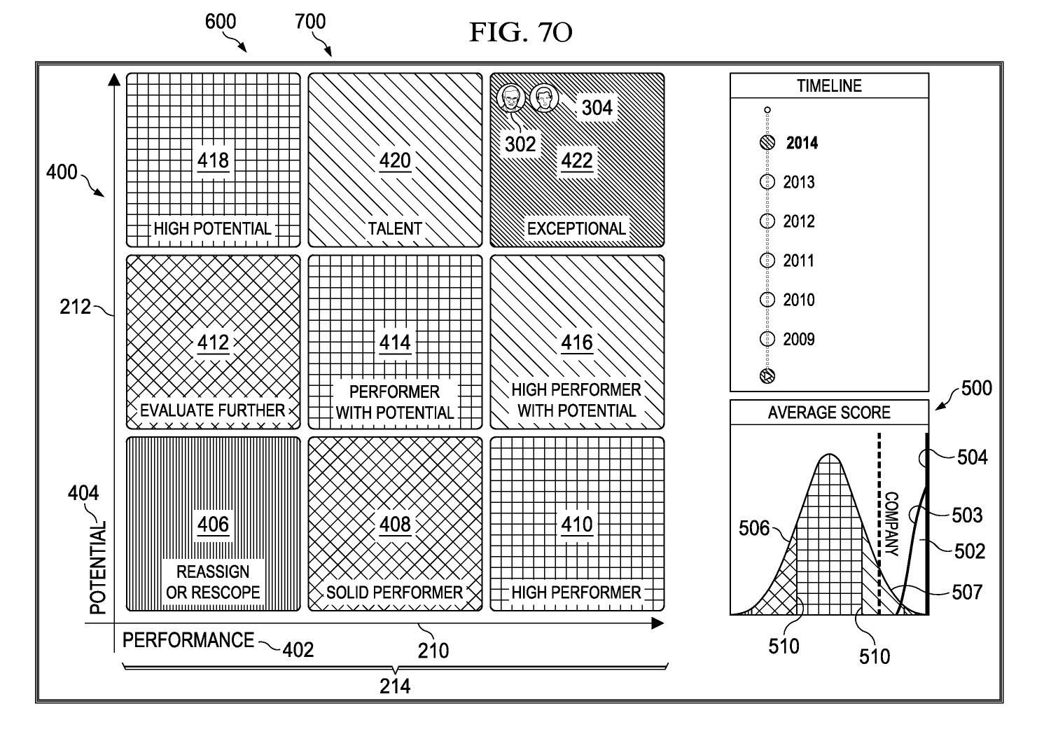

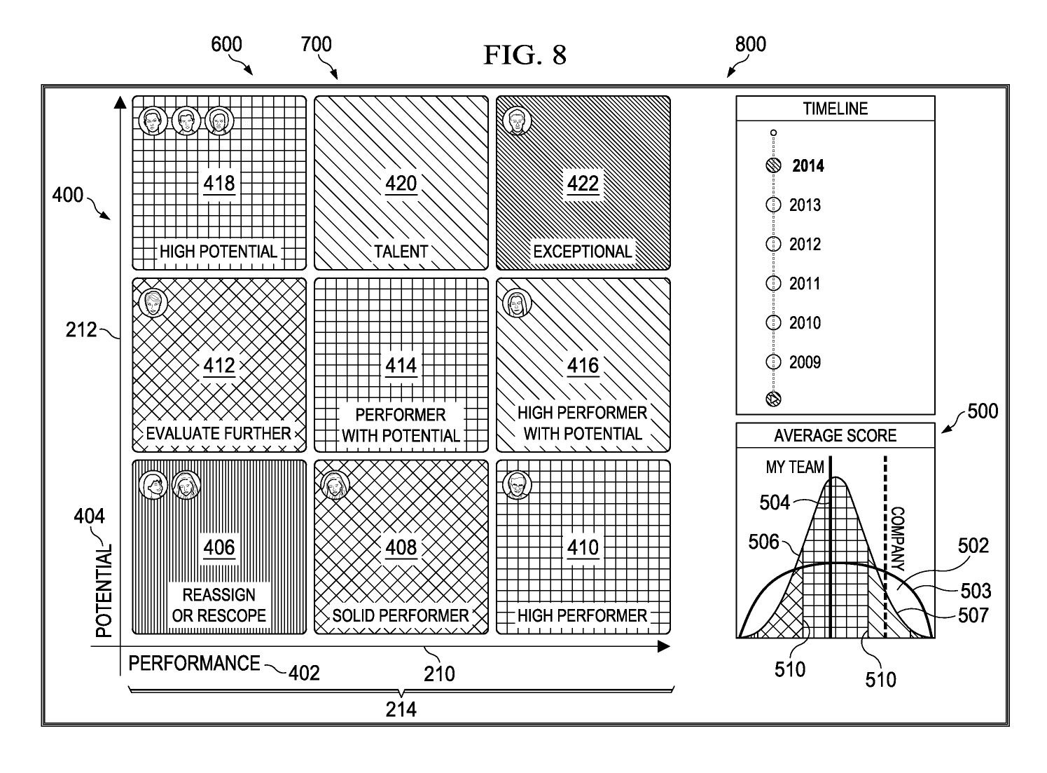

With reference next to FIG. 8, an illustration of an evaluation chart and an aggregate evaluation graph for biased evaluations of group of employee within a graphical user interface is depicted in accordance with an illustrative embodiment. As depicted, graphical user interface 800 is an example of graphical user interface 200 in FIG. 2.

Supervisor 106 enters employee evaluations 108 into the evaluation chart 200 of graphical user interface 800 for each of employee group 204 by associating one of with one of the plurality of fields 214. As depicted, employee group 204 can be associated with one of the plurality fields 214 when supervisor 106 places employee group 204 into plurality of fields 214.

As depicted, graphical user interface 800 depicts biased evaluation 802. Biased evaluation 802 is an example of biased evaluation 124. According to biased evaluation 802, employee 302 and employee 304 are shown in field of 406. Employee 306 is shown in field 408. Employee 308 is shown in field 410. Employee 310 is shown in field 412. Employee 312 is shown in field 416. Employee 314, employee 316, employee 318 are shown in field 418. Employee 320 is shown in field 422.

Based on employee evaluations 108 for employee group 204, aggregate evaluation graph 500 displays biased plot 502 of the distribution 125 of employee evaluations 108 as entered into evaluation chart 400. As depicted, biased mean 504 is within acceptable tolerances 510. Evaluation auditor 140 may therefore accept distribution 125 as shown in biased plot 502. Employee evaluation system 102 can simply records biased evaluation 124 as rationalized evaluation 142 without suggesting alterations to distribution 125, as shown in biased plot 502, of employee evaluations 108.

As depicted, the shape of biased probability curve 503 does not approximate the shape of ideal probability curve 507. Therefore, evaluation auditor 140 may alternatively suggest suggestions 140 for at least one of employee 302 and employee 304 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that the shape of biased probability curve 503 more closely approximates the shape of ideal probability curve 507.

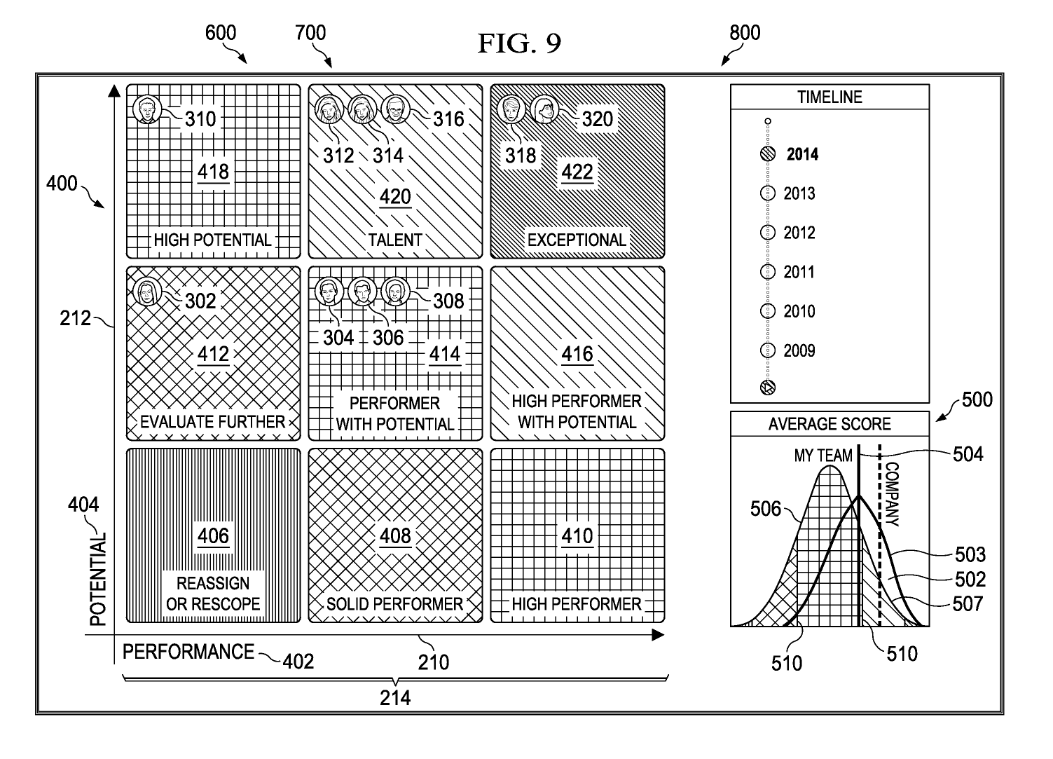

With reference next to FIG. 9, an illustration of an evaluation chart and an aggregate evaluation graph for biased evaluations of group of employee within a graphical user interface is depicted in accordance with an illustrative embodiment. As depicted, graphical user interface 900 is an example of graphical user interface 200 in FIG. 2.

As depicted, graphical user interface 900 depicts biased evaluation 902. Biased evaluation 902 is an example of biased evaluation 124. According to biased evaluation 902, employee 302 is shown in field 412. Employee 304, employee 306 and employee 308 are shown in field 414. Employee 310 is shown in field 418. Employee 312, employee 314, and employee 316 are shown in field 420. Employee 318 and employee 320 are shown in field 422.

Based on employee evaluations 108 for employee group 204, aggregate evaluation graph 500 displays biased plot 502 of the distribution 125 of employee evaluations 108 as entered into evaluation chart 400. As depicted, biased mean 504 is above acceptable tolerances 510.

Evaluation auditor 140 may therefore suggest suggestions 140 for at least one of employee 302 and employee 304 based on discrepancies identified between distribution 125 as shown in biased plot 502 and ideal distribution 132 as shown in ideal plot 506. In one illustrative embodiment, evaluation auditor 140 suggests alterations to employee evaluations 108 of employee 302 such that distribution 125 more closely approximates ideal distribution 132.

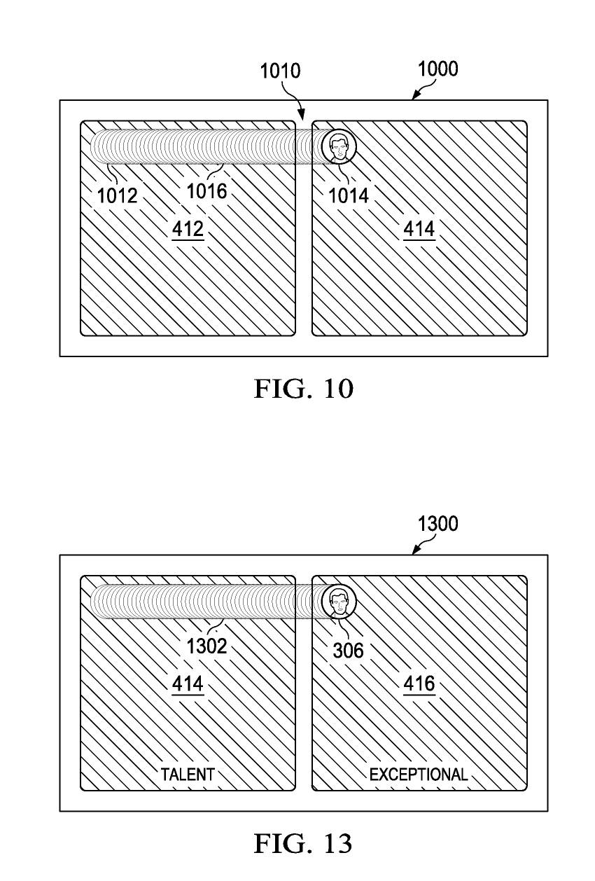

With reference next to FIG. 10, an illustration of a suggestion for an employee displayed in an evaluation chart within a graphical user interface is depicted in accordance with an illustrative embodiment. As depicted, graphical user interface 1000 is an example of graphical user interface 200 in FIG. 2.

Based on discrepancies identified between distribution 125 as shown in biased plot 502 and ideal distribution 132 as shown in ideal plot 506, evaluation auditor 140 makes suggestion 1010. Suggestion 1010 is an example of Suggestions 142

As depicted, suggestion 1010 is an alteration to biased evaluations 130 for employee 302 such that distribution 125 more closely approximates ideal distribution 132. As depicted, biased evaluation 124 initially associates employee 302 at phantom position 1012 in field 412.

Based on employee evaluations 108 for employee group 204, evaluation auditor 140 may determine that biased mean 504 is below acceptable tolerances 510. Alternatively, evaluation auditor 140 may determine that the shape of biased probability curve 503 does not approximate the shape of ideal probability curve 507 within acceptable tolerances 510.

In one illustrative embodiment, evaluation auditor 140 makes suggestion 1010 to employee evaluations 108 of employee 302 such that distribution 125 more closely approximates ideal distribution 132. As depicted, suggestion 1010 is a suggested alteration to biased evaluation 124 of employee 302. As depicted, suggestion 1010 suggests altering the association of employee 302 with field 412, to instead associate of employee 302 with field 414.

As depicted, suggestion 1010 illustrates suggested movement of employee 302 from biased location 1012, shown in phantom, to suggested location 1014 in field 414. Relative movement of employee 302 among plurality of fields 214 as suggested by suggestion 1010 can be shown as phantom trail 1016. Phantom trail 1016 is provided to aide supervisor 106 in identifying changes suggested by suggestion 1010.

By providing suggestion 1010, evaluation auditor 140 aides Supervisor 106 in ameliorating discrepancies between distribution 125 as shown in biased plot 502 and ideal distribution 132 as shown in ideal plot 506. Supervisor 106 can accept suggestion 1010 to form rationalized evaluations 142.

Alternatively, supervisor 106 can make individual alterations to biased evaluations 130, ignoring suggestion 1010 in whole or in part. Therefore, rationalized evaluations 142 may not necessarily strictly conform to suggestions 140. However, distribution 125 four rationalized evaluations 142 must still conform to ideal distribution 132 within acceptable tolerances.

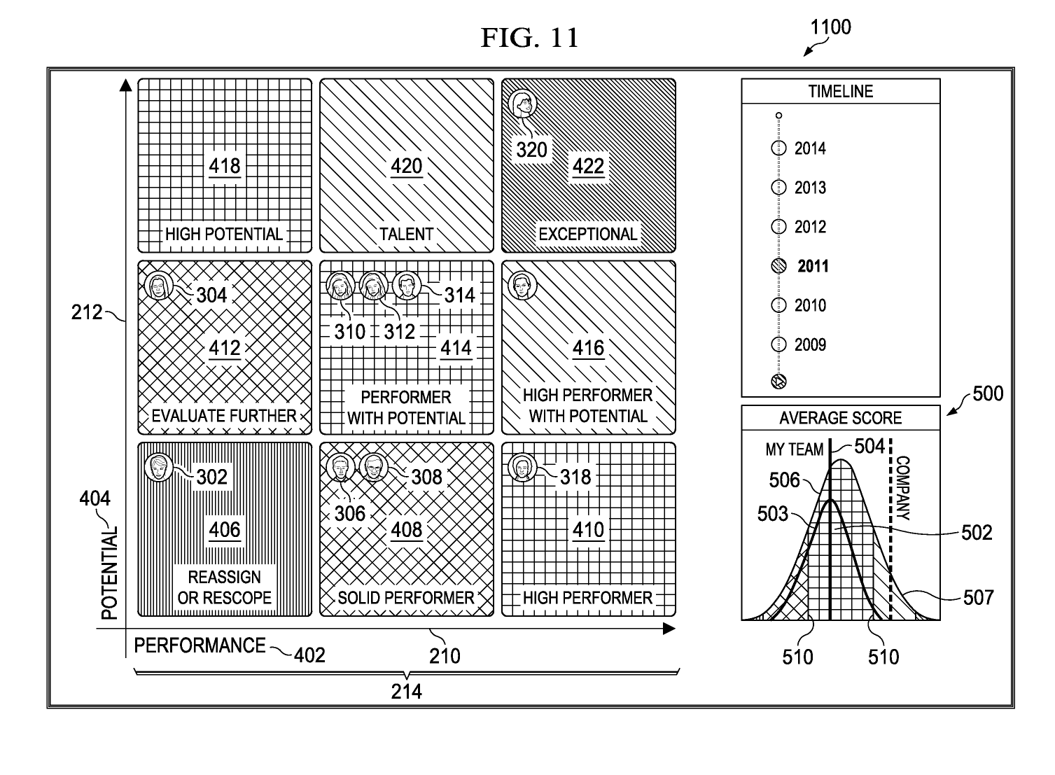

With reference next to FIG. 11, an illustration of an evaluation chart and an aggregate evaluation graph for rationalized evaluations of group of employee within a graphical user interface is depicted in accordance with an illustrative embodiment. As depicted, graphical user interface 1100 depicts a rationalized evaluation for biased evaluations of graphical user interface 900 in FIG. 9.

As depicted, graphical user interface 1100 depicts rationalized evaluation 1102. Rationalized evaluation 1102 is an example of rationalized evaluation 124. As depicted, rationalized evaluation 1102 incorporates at least one of one or more suggestions to biased evaluation 902, such as suggestion 1010, and one or more individual alterations to biased evaluation 902 to determine rationalized evaluation 1102.

As depicted, employee 302 is shown in field 406. Employee 304 is shown in field 408. Employee 306 and employee 308 are shown in field 408. Employee 310, employee 312, and employee 314 are shown in field 414. Employee 316 is shown in field 416. Employee 318 is shown in field 410. Employee 320 is shown in field 422.

Therefore, through at least one of one or more suggestions to biased evaluation 902, such as suggestion 1010, and one or more individual alterations to biased evaluation 902, several of group of employees 200 have been relocated from their initial biased location, such as biased location 1012. As depicted, employee 302 has been relocated from sealed 412 to field 406. Employee 304 has been relocated from field 414 to field 412. Employee 306 and employee 308 have been relocated from field 414 to field 408. Employee 310 has been relocated from field 418 to field 414. Employee 312 has been relocated from field 418 to field 412. Employee 312 and employee 314 have been relocated from sealed 420 to field 414. Employee 316 has been relocated from field 420 to field 416. Employee 318 has been relocated from field 422 to field 410.

Based on employee evaluations 108 for employee group 204, aggregate evaluation graph 500 displays plot 502 of the distribution 125 of rationalized evaluation 1102 as entered into evaluation chart 400. As depicted, biased mean 504 is within acceptable tolerances 510. Evaluation auditor 140 may therefore accept distribution 125 as shown in plot 502. In an illustrative embodiment, employee evaluation system 102 can store rationalized evaluation 1102 as associated with a current time interval within a timeline, such as timeline 220.

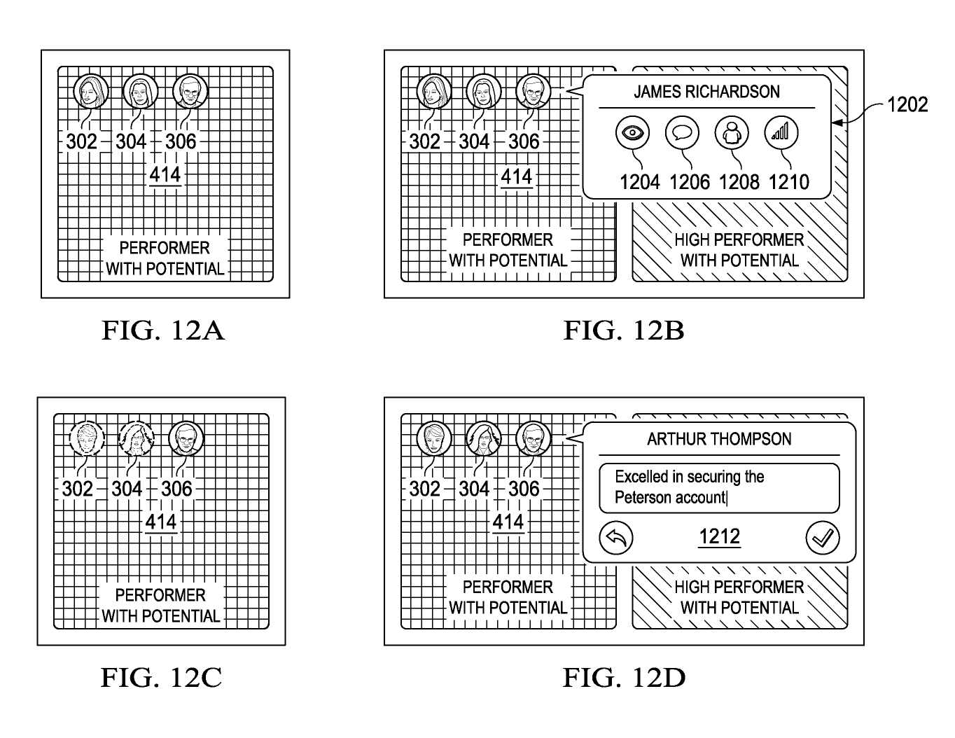

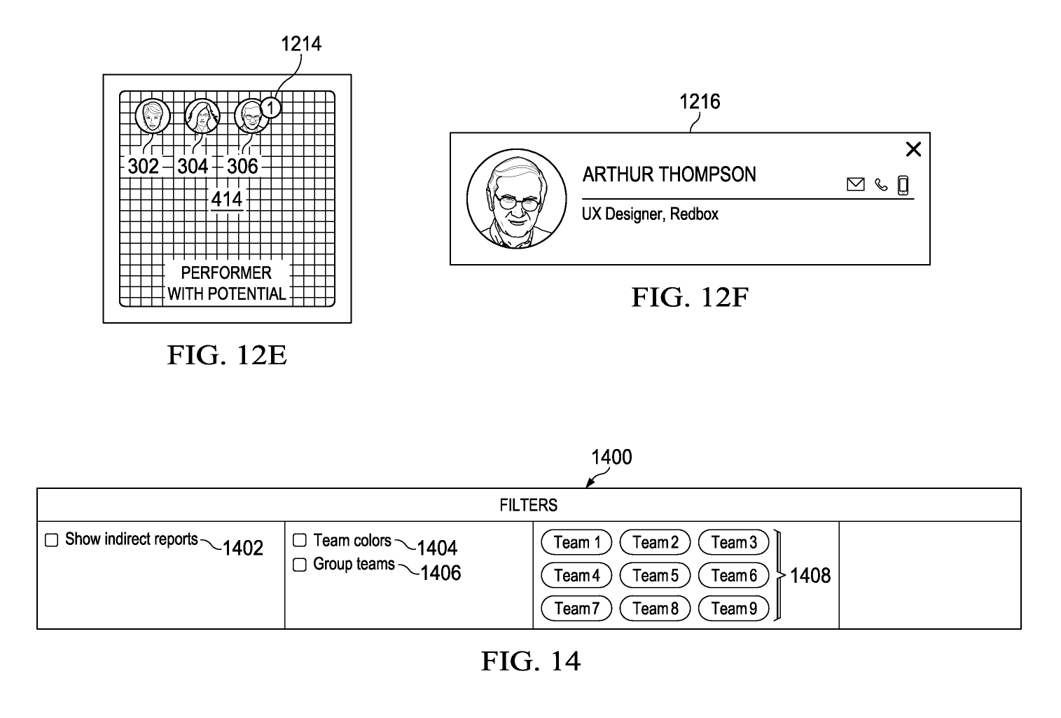

Referring now to FIGS. 12A, 12B, 12C, 12D, 12E, and 12F, an illustration of employee interaction within a graphical user interface is depicted in accordance with an illustrative embodiment. As depicted, graphical user interface 1200 is one or more plurality of fields 214 in evaluation chart 206 of graphical user interface 200 in FIG. 2.

As shown in FIG. 12A, employee 302, employee 304, and employee 306 are associated with a particular one of the plurality of fields 214. As depicted, employee 302, employee 304, and employee 306 are associated with field 414. Employee evaluation 102 provides callouts 1202 to supervisor 106 to facilitate employee evaluations 108.

Referring now to FIG. 12B, callouts 1202 are shown for employee 306. Callouts 1202 can be selectively viewed, for example, by clicking, mousing over, or otherwise selecting employee 306. Callouts 1202 are a number of tools to facilitate employee evaluations 108 by supervisor 106. As depicted, callouts 1202 include employee highlight 1204, employee notation 1206, employee profile 1208, and employee growth 1210.

Referring now to FIG. 12C, an illustration of a selection of employee highlight 1204 from within callouts 1202 is depicted in accordance with an illustrative embodiment. Selection of employee highlight 1204 emphasizes employee 306 to appear more prominently than employee 302 and employee 304 within graphical user interface 1200. As depicted, employee highlight 1204 emphasizes employee 306 by obscuring employee 302 and employee 304.

Referring now to FIG. 12D, an illustration of a selection of employee notation 1206 from within callouts 1202 is depicted in accordance with an illustrative embodiment. Selection of employee notation 1206 opens notation screen 1212. As depicted, notation screen 1212 allows supervisor 106 to enter notations about employee 306 into employee evaluation system 102.

Referring now to FIG. 12E, an illustration of notation count 1214 appended to employee 306 is depicted in accordance with an illustrative embodiment. Notation count 1214 is a graphical depiction of a number of notations that have been appended to employee 306 by using employee notation 1206 and notation screen 1212.

Referring now to FIG. 12F, an illustration of a selection of employee profile 1208 from within callouts 1202 is depicted in accordance with an illustrative embodiment. Selection of employee profile 1208 opens profile screen 1216. As depicted, profile screen 1216 displays additional information about employee 306, including for example but not limited to, at least one of a name of employee 306, a title of employee 306, an e-mail contact for employee 306, and a telephone contact for employee 306.

Referring now to FIG. 13, an illustration of relative movement of an employee within fields of evaluation chart for selected time intervals displayed in a graphical user interface is depicted in accordance with an illustrative embodiment. As depicted, relative movement of employee 306 is shown based on a selection of employee growth 1210 from within callouts 1202. As depicted, graphical user interface 1300 is an example of graphical user interface 200 in FIG. 2.

As depicted, movement of employee 306 from the field 414 to field 416 is shown in phantom trail 1302. Movement of employee 306 from the field 414 to field 416 can be initiated by selecting a time interval from timeline 220. Phantom trail 1302 is provided to aide supervisor 106 in identifying growth, stagnation, or regression of employee 306 as determined from rationalized evaluations 142 for prior time intervals.

Referring now to FIG. 14, an illustration of chart filters within a graphical user interface is depicted in accordance with an illustrative embodiment. Chart filters 1400 is an example of chart sensors 216 of FIG. 2 of interface 200.

Chart filters 1400 are various view filters that can be applied to the at least one of employee group 204, teams of employees 104, other groups of employees 104, or employees 104. As depicted, chart filters 1400 includes direct/indirect report toggle 1402, team color toggle 1404, group teams toggle 1406, and teams plurality of toggles 1408.

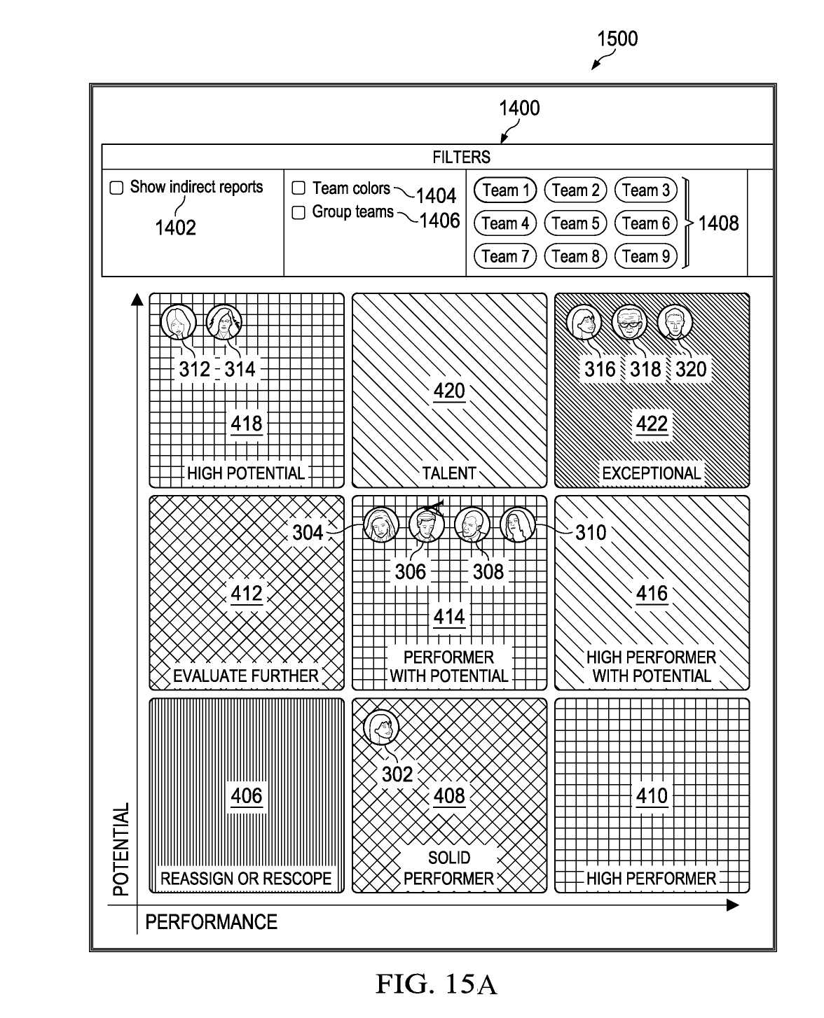

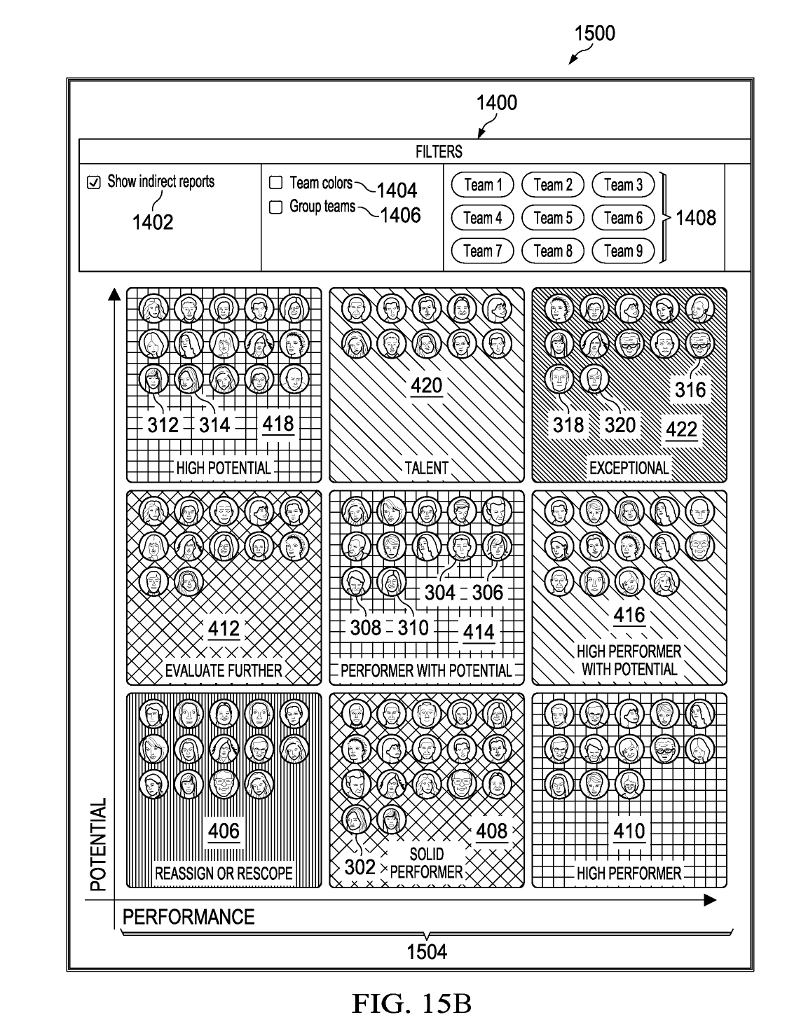

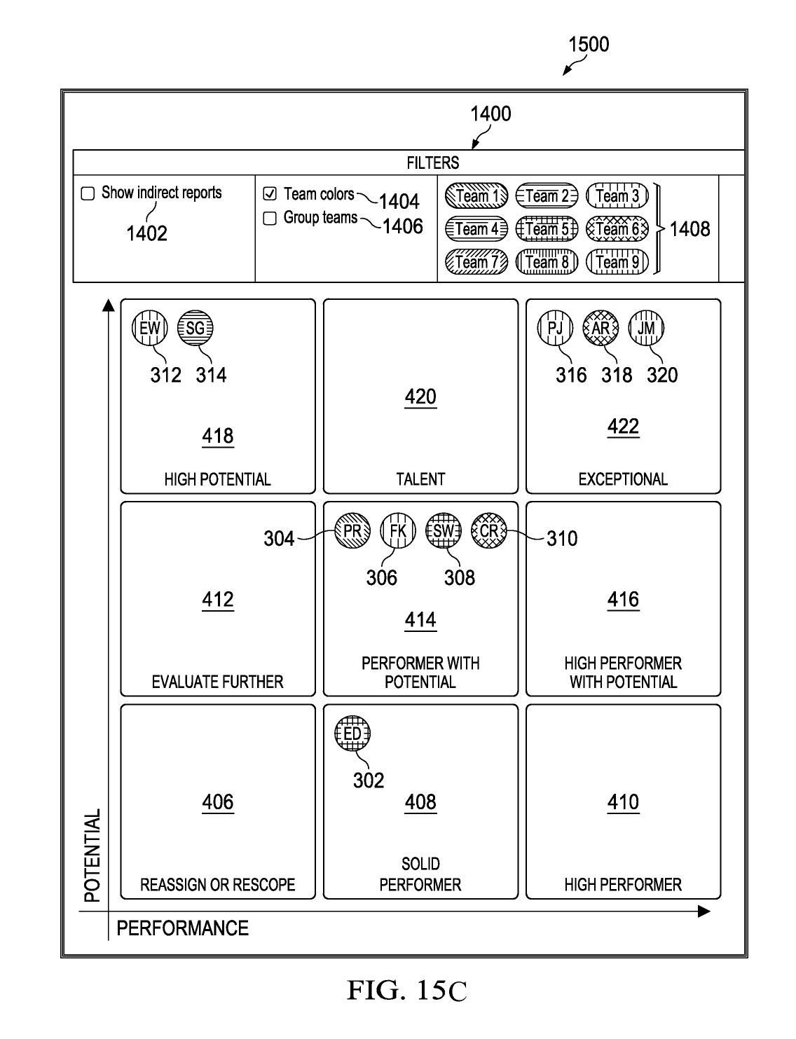

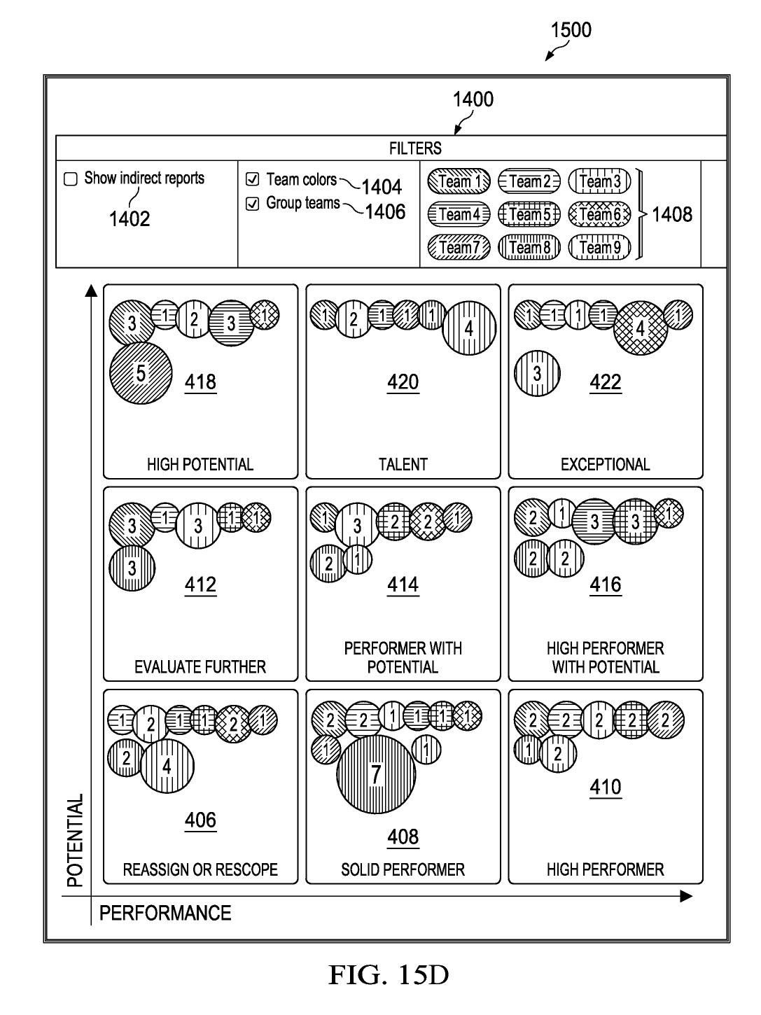

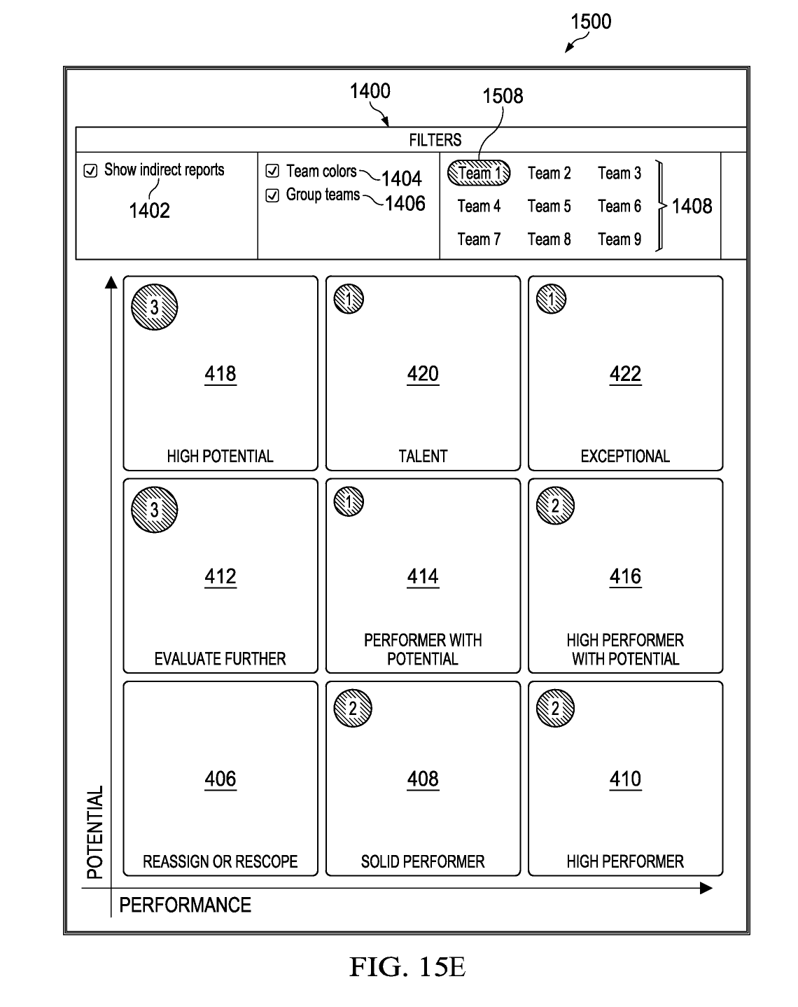

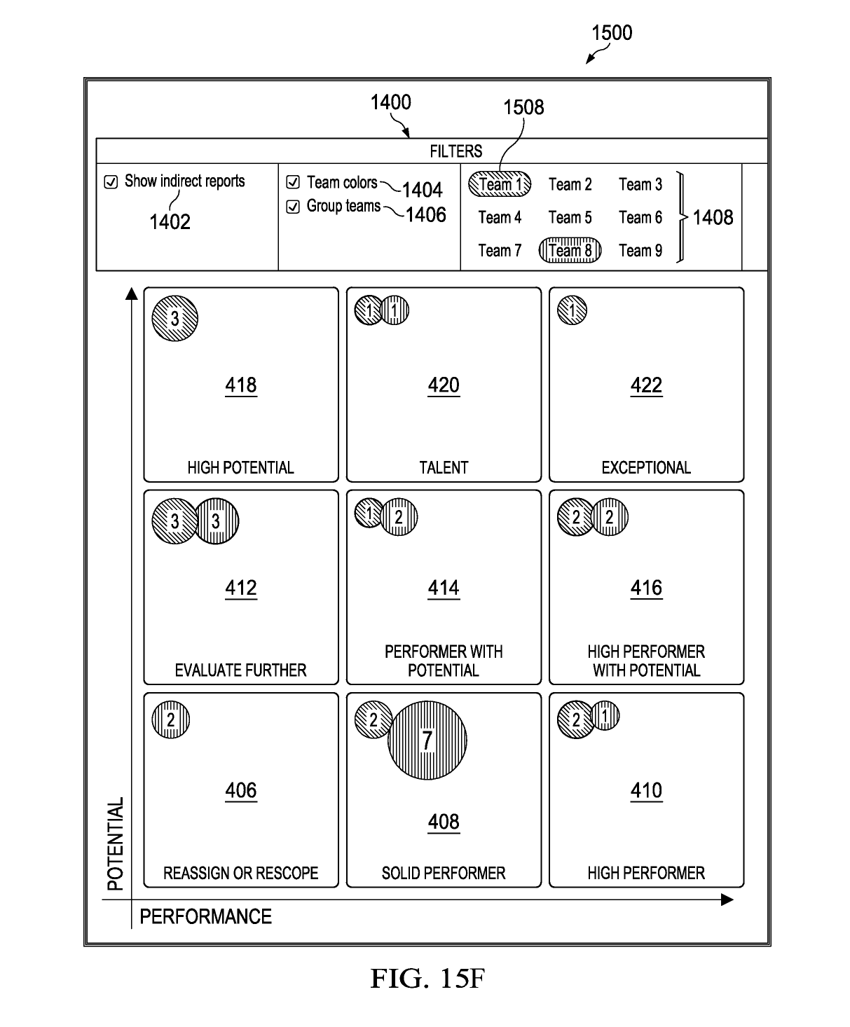

Referring now to FIGS. 15A, 15B, 15C, 15D, 15E, and 15F, an illustration of an interactive relationship between chart filters and an evaluation chart within a graphical user interface is depicted in accordance with an illustrative embodiment. As depicted, graphical user interface 1500 is an example of graphical user interface 200 in FIG. 2.

As shown in FIG. 15A, each of employee group 204 is associated with one of plurality of fields 214. As depicted, employee 302 is shown in fields 408. Employee 304, employee 306, employee 308, and employee 310 are shown in field 414. Employee 312 and employ 314 are shown in field 418. Employees 316, employee 318, an employee 320 are shown in field 422. As depicted, each of direct/indirect report toggle 1402, team color toggle 1404, group teams toggle 1406, and teams plurality of toggles 1408 are unselected.

Referring now to FIG. 15B, an illustration of an interactive relationship between chart filters and an evaluation chart showing a selection of direct/indirect report toggle 1402 is depicted in accordance with an illustrative embodiment. As depicted, each of employee group 204 is a direct report to supervisor 106.

As depicted, direct/indirect report toggle 1402 is selected. Based on the selection of direct/indirect reports toggle 1502, graphical user interface 1500 displays indirect reports 1504 in addition to employee group 204. Direct/indirect report toggle 1402 allow supervisor 106 to view employee evaluations 108 for at least one of indirect reports 1504 and employee group 204.

Referring now to FIG. 15C, an illustration of an interactive relationship between chart filters and an evaluation chart showing a selection of team color toggle 1404 is depicted in accordance with an illustrative embodiment. As depicted, different teams of employees are assigned color identifiers. Team color toggle 1404 allows supervisor 106 to view individual employee evaluations 108 with regard to an associated team for at least one of employee group 204 and indirect reports 1504.

Referring now to FIG. 15D, an illustration of an interactive relationship between chart filters and an evaluation chart showing a selection of group teams toggle 1406 is depicted in accordance with an illustrative embodiment. As depicted, a selection of group teams toggle 1406 aggregates at least one of employee group 204 and indirect reports 1504 within their respective ones of plurality of fields 400 X to form aggregate identifiers 1506. Group teams toggle 1406 allows supervisor 106 to aggregately view employee evaluations 108 with regard to an associated team for at least one of employee group 204 and indirect reports 1504.

Referring now to FIG. 15E, an illustration of an interactive relationship between chart filters and an evaluation chart showing a selection of a single one of teams plurality of toggles 1408 is depicted in accordance with an illustrative embodiment. As depicted, each of teams plurality of toggles 1408 are deselected, with the exception of team 1508. The singular selection of team 1508 from obscures unselected teams from evaluation chart 400.

Referring now to FIG. 15F, an illustration of an interactive relationship between chart filters and an evaluation chart showing a selection of two of teams plurality of toggles 1408 is depicted in accordance with an illustrative embodiment. As depicted, each of teams plurality of toggles 1408 are deselected, with the exception of team 1508 and team 1510. The selection of team 1508 and team 1508 from obscures unselected teams from the evaluation chart 400.

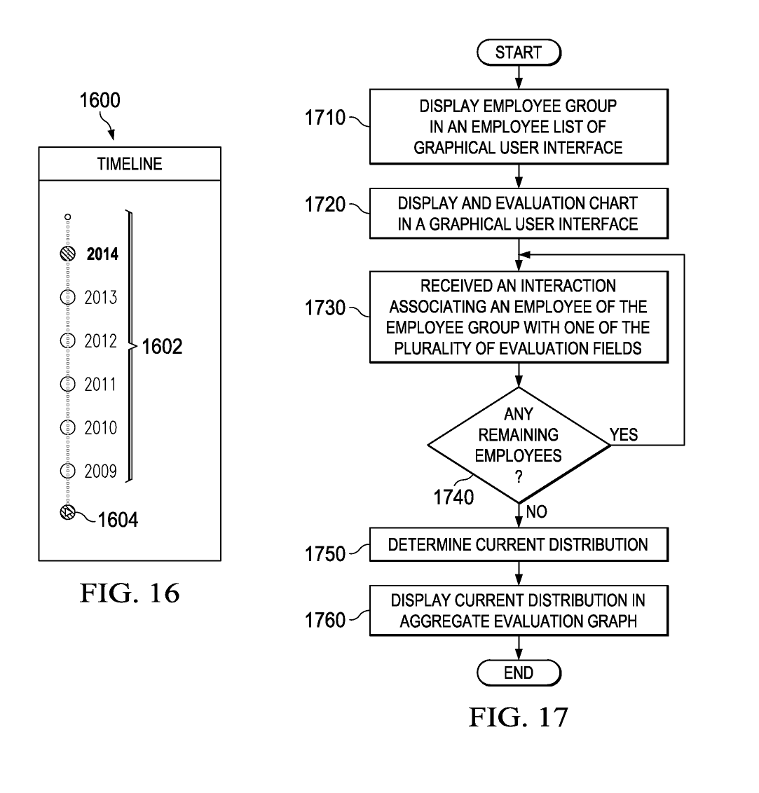

Referring now to FIG. 16, an illustration of a time line within a graphical user interface is depicted in accordance with an illustrative embodiment. Time line 1600 is an example of time line 220 of interface 200 of FIG. 2.

Timeline 1600 includes plurality of evaluation dates 1602. Each of plurality of evaluation dates 1602 is a date associated with a rationalized evaluation, such as rationalize evaluations 144, within employee evaluation system 102.

Timeline 1600 includes play button 1604. Play button 1604 is an interactive icon that allows a stepwise animated view of rationalized evaluations for employee group 204 displayed within the evaluation chart 206 as recorded within employee evaluation system 102 at evaluation dates 1602.

With reference next to FIG. 17, an illustration of a flowchart of a process for receiving employee evaluations in an employee evaluation system is shown according to an illustrative embodiment. Process 1700 may be implemented in employee evaluation system 102 in employee evaluation environment 100 in FIG. 1.

Process 1700 begins by displaying employee group in an employee list of a graphical user interface (step 1710). The employee group can be, for example, employee group 204 of FIG. 2.

Process 1700 displays an evaluation chart comprising a plurality of evaluation fields in a graphical user interface (step 1720). The evaluation chart can be, for example, the evaluation chart 206 of FIG. 2.

Process 1700 receives an interaction associating an employee of the employee group with one of the plurality of evaluation fields (step 1730). The interaction can be by a supervisor, such as supervisor 106. As depicted, an employee can be associated with one of the plurality fields when the supervisor places the employee into the field. In an illustrative embodiment, the supervisor can drag the employee from the employee list into one of plurality of fields.

Process 1700 determines if there are any remaining employees within the employee group (step 1740). If process 1700 determines that there are remaining employees (“yes” at step 1740), process 1700 iterates back to step 1730.

If process 1700 does not determine that there are remaining employees (“no” at step 1740), process 1700 determines a current distribution for the employee evaluation (step 1750). Process 1700 displays the current distribution in an aggregate evaluation graph (step 1760), with the process terminating thereafter. The aggregate evaluation graph can be, for example aggregate evaluation graph 218 in FIG. 2.

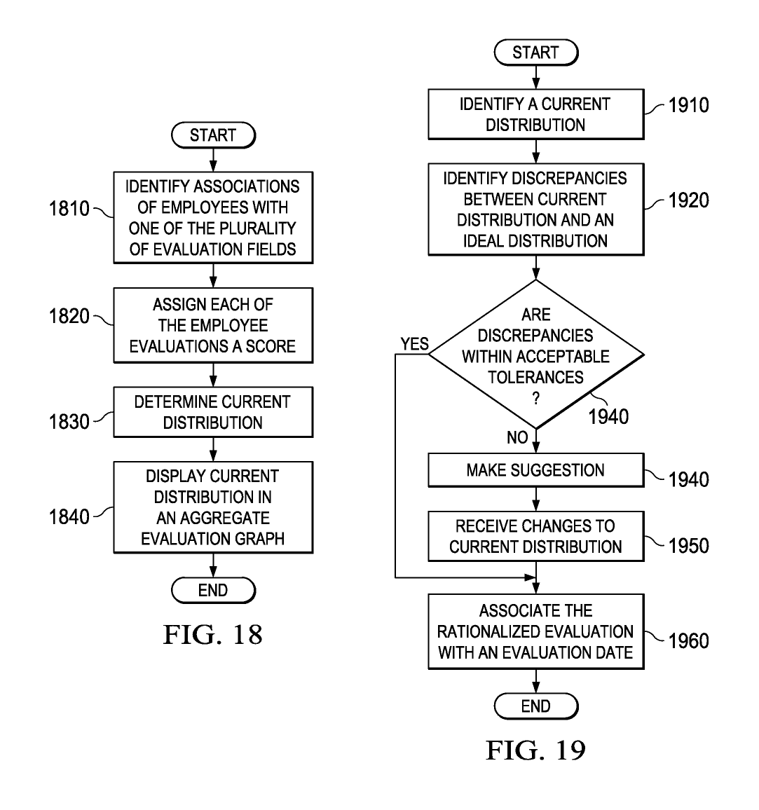

With reference next to FIG. 18, an illustration of a flowchart of a process for determining a current distribution of employee evaluations is shown according to an illustrative embodiment. Process 1800 may be implemented in evaluation auditor 140 in employee evaluation system 102 in employee evaluation environment 100 in FIG. 1. Process 1800 is a more detailed depiction of process steps 1750-1760 of FIG. 17.

Process 1800 begins by identifying associations of employees with one of the plurality of evaluation fields (step 1810). The associations can be made, for example, through an interaction associating an employee of the employee group with one of the plurality of evaluation fields, as shown in step 1730.

Process 1800 assigns each of employee evaluations a score (step 1820). The score can be a numeric score based on a position within the evaluation chart. The scores can then be adjusted by applying parameter weights, such as parameter weights 129, to emphasize certain evaluation parameters, such as evaluation parameters 128, when determining the relative performance of the employees.

Process 1800 then determines a current distribution (step 1830). The current distribution can be, for example, current distribution 125 in FIG. 1. Process 1800 displays the current distribution in an aggregate evaluation graph (step 1840), with the process terminating thereafter. The aggregate evaluation graph can be, for example aggregate evaluation graph 218 in FIG. 2. According to an illustrative embodiment, process 1800 can display the current distribution in the aggregate evaluation graph by overlaying the current distribution with an ideal distribution, such as ideal distribution 132 of FIG. 1.

Referring now to FIG. 19, an illustration of a flowchart of a process for making a suggestion to biased employee evaluations is shown according to an illustrative embodiment. Process 1900 may be implemented in an evaluation auditor 140 of employee evaluation system 102 of employee evaluation environment 100 in FIG. 1.

Process 1900 begins by identifying current distribution (step 1910). The current distribution can be, for example current distribution 125 in FIG. 1.

Process 1900 identifies discrepancies between the current distribution and an ideal distribution (step 1920). The ideal distribution can be, for example ideal distribution 132 FIG. 1. The discrepancies can be, for example, at least one of a discrepancy between a current mean and an ideal mean, and a discrepancy between the current plot shape and an ideal plot shape.

Process 1900 determines whether discrepancies are within acceptable tolerances (step 1930). The acceptable tolerances can be, for example, acceptable tolerances 510 of FIG. 5.

Responsive to determining that the discrepancies are within acceptable tolerances (“yes” at step 1930), process 1900 proceeds directly to step 1960. Response to determining that the discrepancies are not within acceptable tolerances (“no” at step 1930), process 1900 makes suggestions (step 1940). The suggestions can be, for example suggestions 142 of FIG. 1. Process 1900 can make suggestion by displaying the suggestion, such as suggestion 1000, in an evaluation chart, such as evaluation chart 206.

Process 1900 receives changes to the current distribution (step 1950). The changes can be received in the form of a rationalized evaluation, such as for example, rationalized evaluation 144 of FIG. 1. Process 1900 then associates the rationalized evaluation with an evaluation date (step 1960), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

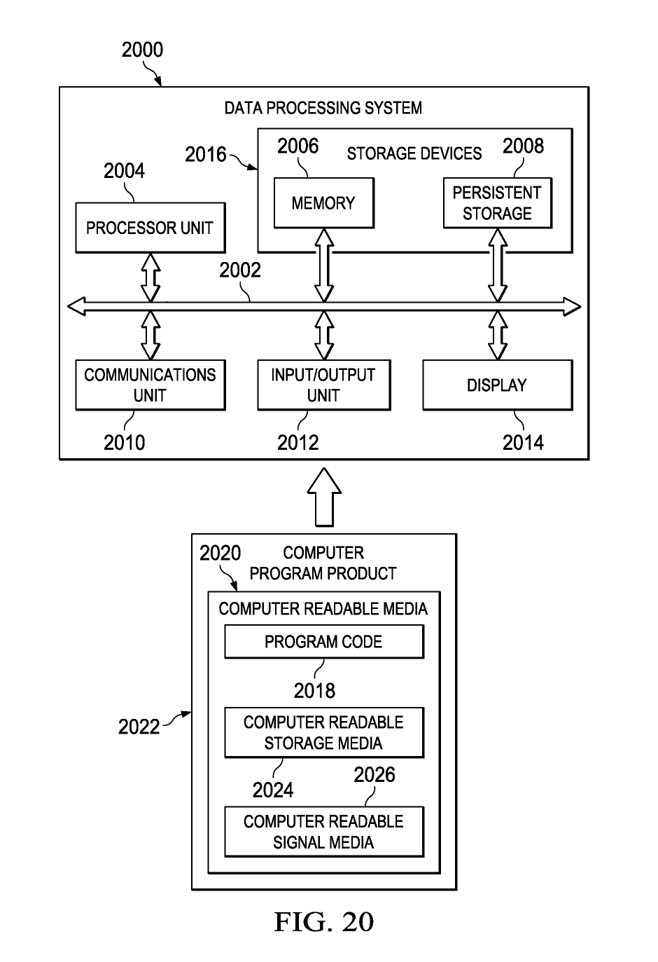

Turning now to FIG. 20, an illustration of a block diagram of a data processing system is depicted in accordance with an illustrative embodiment. Data processing system 2000 may be used to implement one or more data processing systems in employee evaluation system 102 in FIG. 1. In this illustrative example, data processing system 2000 includes communications framework 2002, which provides communications between processor unit 2004, memory 2006, persistent storage 2008, communications unit 2010, input/output (I/O) unit 2012, and display 2014. In this example, communication framework may take the form of a bus system.

Processor unit 2004 serves to execute instructions for software that may be loaded into memory 2006. Processor unit 2004 may be a number of processors, a multi-processor core, or some other type of processor, depending on the particular implementation.

Memory 2006 and persistent storage 2008 are examples of storage devices 2016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2016 may also be referred to as computer readable storage devices in these illustrative examples. Memory 2006, in these examples, may be, for example, a random access memory or any other suitable volatile or non-volatile storage device. Persistent storage 2008 may take various forms, depending on the particular implementation.

For example, persistent storage 2008 may contain one or more components or devices. For example, persistent storage 2008 may be a hard drive, a flash memory, a rewritable optical disk, a rewritable magnetic tape, or some combination of the above. The media used by persistent storage 2008 also may be removable. For example, a removable hard drive may be used for persistent storage 2008.

Communications unit 2010, in these illustrative examples, provides for communications with other data processing systems or devices. In these illustrative examples, communications unit 2010 is a network interface card.

Input/output unit 2012 allows for input and output of data with other devices that may be connected to data processing system 2000. For example, input/output unit 2012 may provide a connection for user input through at least of a keyboard, a mouse, or some other suitable input device. Further, input/output unit 2012 may send output to a printer. Display 2014 provides a mechanism to display information to a user.

Instructions for at least one of the operating system, applications, or programs may be located in storage devices 2016, which are in communication with processor unit 2004 through communications framework 2002. The processes of the different embodiments may be performed by processor unit 2004 using computer-implemented instructions, which may be located in a memory, such as memory 2006.

These instructions are referred to as program code, computer usable program code, or computer readable program code that may be read and executed by a processor in processor unit 2004. The program code in the different embodiments may be embodied on different physical or computer readable storage media, such as memory 2006 or persistent storage 2008.

Program code 2018 is located in a functional form on computer readable media 2020 that is selectively removable and may be loaded onto or transferred to data processing system 2000 for execution by processor unit 2004. Program code 2018 and computer readable media 2020 form computer program product 2022 in these illustrative examples. In one example, computer readable media 2020 may be computer readable storage media 2024 or computer readable signal media 2026.

In these illustrative examples, computer readable storage media 2024 is a physical or tangible storage device used to store program code 2018 rather than a medium that propagates or transmits program code 2018.

Alternatively, program code 2018 may be transferred to data processing system 2000 using computer readable signal media 2026. Computer readable signal media 2026 may be, for example, a propagated data signal containing program code 2018. For example, computer readable signal media 2026 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2000 are not meant to provide architectural limitations to the manner in which different embodiments may be implemented. The different illustrative embodiments may be implemented in a data processing system including components in addition to or in place of those illustrated for data processing system 2000. Other components shown in FIG. 20 can be varied from the illustrative examples shown. The different embodiments may be implemented using any hardware device or system capable of running program code 2018.

Thus, the illustrative embodiments provide a method and apparatus for graphically displaying data within an employee evaluation system that identifies relative performance of employees is presented. A computer system identifies locations for a group of employee evaluations on a two axis chart that is to be graphically displayed on a display system. The computer system identifies performance results for the group of employees that is to be graphically displayed on the display system. The computer system compares the performance results to ideal performance results. The computer system displays the group of employees on the two axis chart of the graphical user interface and display system. The first axis is a potential and performance for the group of employees. The second axis is an actual performance of the group of employees. The computer system displays the comparison of the performance results to the ideal performance results on a graph on the graphical user interface. Displaying the chart and graph on a graphical user interface enables identification of relative performance of the group of employees.

Based on the comparison between the performance results in the ideal performance result, the method may further include graphically displaying a recommendation to rationalize the performance results to an ideal performance results. The computer system may further identify a recommendation for a rationalized performance result that more closely approximate the performance results to the ideal performance results. The computer system displays the recommendation for the rationalized performance results on the two axis chart of the graphical user interface and display system. Displaying the recommendation for a rationalized performance result chart on the two axis chart of the graphical user interface and display system enables remediation of in group bias that may be present within the performance results.

In this manner, the evaluation of employees as part of an employee evaluation system can be made more easily as compared to currently used techniques. Because employee evaluations are relatively free from in group bias, a more evenhanded comparison of evaluations between different employee groups is realized by the organization. As a result, the organization can better compare the relative performance of employees assigned to different employee groups within the organization. Furthermore, by evaluating employees as part of an employee evaluation system, an identification of the relative performance of the group of employees is enabled.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. In particular, evaluation auditor is configured to perform the different operations described as well as other operations using at least one of program code, hardware, firmware, or other suitable components.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for identifying relative performance of employees, the method comprising:
identifying, by a computer system, locations for a group of the employees on a two axis chart in which a first axis is a potential performance for the group of employees and a second axis is an actual performance;
displaying, by a computer system, the group of the employees on the chart on a graphical user interface in a display system;
identifying, by a computer system, a performance result for the group of employees; and
displaying, by a computer system, the performance result on a graph on the graphical user interface, wherein displaying the chart and the graph on graphical user interface enable identification of relative performance of the group of employees.

2. The method of claim 1, wherein the performance result is a user-biased performance result.

3. The method of claim 2, wherein the user-biased performance result is displayed on the graph on the graphical user interface as a user-biased bell curve.

4. The method of claim 2 further comprising:
displaying an ideal performance result on the graph on the graphical user interface.

5. The method of claim 4, wherein the ideal performance result is displayed on the graph on the graphical user interface as an ideal bell curve.

6. The method of claim 5, further comprising:
identifying rationalized locations on the two axis chart for the group of employees;
identifying a rationalized performance result for the group of employees; and
displaying the rationalized performance result on the graph on the graphical user interface, wherein rationalized performance result is a closest approximation of the ideal performance result.

7. The method of claim 5, wherein the rationalized performance result is displayed on the graph on the graphical user interface as a rationalized bell curve.

8. The method of claim 6 further comprising:
correlating the rationalized performance result for the group of employees to a timeline displayed on the graphical user interface, the timeline comprising a number of selectable dates in which the chart reflects the rationalized locations and the graph reflects the rationalized performance for the group of employees for a selected date on the displayed timeline.

9. The method of claim 7 further comprising:
identifying a selection of a play button for the timeline; and
responsive to identifying the selection of the play button, sequentially displaying the rationalized locations in the chart over the number of selectable dates in the timeline; and
responsive to identifying the selection of the play button, sequentially displaying the rationalized performance in the chart over the number of selectable dates in the timeline.

10. The method of claim 9, wherein sequentially displaying the rationalized locations further comprises:
displaying a group of trailing images in the chart for the group of employees, wherein the group of trailing images indicates change in performance for the group of employees over the number of selectable dates in the timeline.

11. The method of claim 10 further comprising:
identifying a selection of a particular employee in the group of employees; and
responsive to identifying the selection of the particular employee, obscuring trailing images for other employees in the group of employees and displaying trailing images in the chart for the particular employee, wherein the trailing images the particular employee indicate change in performance for the particular employee over the number of selectable dates in the timeline.

12. The method of claim 1, wherein the two axis chart comprises a plurality of boxes arranged in a grid, the locations for the group of employees being within the plurality of boxes.

13. The method of claim 12, wherein the plurality of boxes is 9 boxes arranged in a 3×3 grid.

14. The method of claim 1, wherein the group of employees is a plurality of employees.

15. The method of claim 14, wherein the plurality of employees comprises a first department of a plurality of departments of employees within a corporation.

16. A computer system comprising:
a display system; and
an evaluation auditor of an employee evaluation system in the computer system in communication with the display system, wherein the evaluation auditor identifies locations for a group of the employees on a two axis chart in which a first axis is a potential performance for the group of employees and a second axis is an actual performance; displays the group of the employees on the chart on a graphical user interface in the display system; identifies a performance result for the group of employees; and displays the performance result on a graph on the graphical user interface, wherein displaying the chart and the graph on graphical user interface enable identification of relative performance of the group of employees.

17. The computer system of claim 16, wherein the performance result is a user-biased performance result.

18. The computer system of claim 17, wherein the user-biased performance result is displayed on the graph on the graphical user interface as a user-biased bell curve.

19. The computer system of claim 18, wherein the evaluation auditor displays an ideal performance result on the graph on the graphical user interface.

20. The computer system of claim 19, wherein the ideal performance result is displayed on the graph on the graphical user interface as an ideal bell curve.

21. The computer system of claim 20, wherein the evaluation auditor identifies rationalized locations on the two axis chart for the group of employees; identifies a rationalized performance result for the group of employees; and displays the rationalized performance result on the graph on the graphical user interface, wherein rationalized performance result is a closest approximation of the ideal performance result.

22. The computer system of claim 21, wherein the rationalized performance result is displayed on the graph on the graphical user interface as a rationalized bell curve.

23. The computer system of claim 22, wherein the evaluation auditor correlates the rationalized performance result for the group of employees to a timeline displayed on the graphical user interface, the timeline comprising a number of selectable dates in which the chart reflects the rationalized locations and the graph reflects the rationalized performance for the group of employees for a selected date on the displayed timeline.

24. The computer system of claim 23, wherein the employee evaluation system identifies a selection of a play button for the timeline; sequentially displays the rationalized locations in the chart over the number of selectable dates in the timeline in response to identifying the selection of the play button; and sequentially displaying the rationalized performance in the chart over the number of selectable dates in the timeline in response to identifying the selection of the play button.

25. The computer system of claim 24, wherein sequentially displaying the rationalized locations further comprises:
displaying a group of trailing images in the chart for the group of employees, wherein the group of trailing images indicates change in performance for the group of employees over the number of selectable dates in the timeline.

26. The computer system of claim 24, wherein the employee evaluation system identifies a selection of a particular employee in the group of employees; and obscures trailing images for other employees in the group of employees and displaying trailing images in the chart for the particular employee in response to identifying the selection of the particular employee, wherein the trailing images the particular employee indicate change in performance for the particular employee over the number of selectable dates in the timeline.

27. The computer system of claim 16, wherein the two axis chart comprises a plurality of boxes arranged in a grid, the locations for the group of employees being within the plurality of boxes.

28. The computer system of claim 27, wherein the plurality of boxes is 9 boxes arranged in a 3×3 grid.

29. The computer system of claim 28, wherein the group of employees is a plurality of employees.

30. The computer system of claim 29, wherein the plurality of employees comprises a first department of a plurality of departments of employees within a corporation.

31. A computer program product for identifying relative performance of employees, the computer program product comprising:
a computer readable storage media;
first program code, stored on the computer readable storage media, for identifying locations for a group of the employees on a two axis chart in which a first axis is a potential performance for the group of employees and a second axis is an actual performance;
second program code, stored on the computer readable storage media, for displaying the group of the employees on the chart on a graphical user interface in a display system;
third program code, stored on the computer readable storage media, for identifying a performance result for the group of employees; and
fourth program code, stored on the computer readable storage media, for displaying the performance result on a graph on the graphical user interface, wherein displaying the chart and the graph on graphical user interface enable identification of relative performance of the group of employees.

32. The computer program product of claim 31, wherein the performance result is a user-biased performance result.

33. The computer program product of claim 32, wherein the user-biased performance result is displayed on the graph on the graphical user interface as a user-biased bell curve.

34. The computer program product of claim 33 further comprising:
fifth program code, stored on the computer readable storage media, for displaying an ideal performance result on the graph on the graphical user interface.

35. The computer program product of claim 34, wherein the ideal performance result is displayed on the graph on the graphical user interface as an ideal bell curve.

36. The computer program product of claim 35, further comprising:
sixth program code, stored on the computer readable storage media, for identifying rationalized locations on the two axis chart for the group of employees;
seventh program code, stored on the computer readable storage media, for identifying a rationalized performance result for the group of employees; and
eighth program code, stored on the computer readable storage media, for displaying the rationalized performance result on the graph on the graphical user interface, wherein rationalized performance result is a closest approximation of the ideal performance result.

37. The computer program product of claim 36, wherein the rationalized performance result is displayed on the graph on the graphical user interface as a rationalized bell curve.

38. The computer program product of claim 36 further comprising:
ninth program code, stored on the computer readable storage media, for correlating the rationalized performance result for the group of employees to a timeline displayed on the graphical user interface, the timeline comprising a number of selectable dates in which the chart reflects the rationalized locations and the graph reflects the rationalized performance for the group of employees for a selected date on the displayed timeline.

39. The computer program product of claim 37 further comprising:
ninth program code, stored on the computer readable storage media, or identifying a selection of a play button for the timeline; and
tenth program code, stored on the computer readable storage media, for sequentially displaying the rationalized locations in the chart over the number of selectable dates in the timeline in response to identifying the selection of the play button; and
eleventh program code, stored on the computer readable storage media, for sequentially displaying the rationalized performance in the chart over the number of selectable dates in the timeline in response to identifying the selection of the play button.

40. The computer program product of claim 39, wherein tenth program code for sequentially displaying the rationalized locations further comprises:
program code for displaying a group of trailing images in the chart for the group of employees, wherein the group of trailing images indicates change in performance for the group of employees over the number of selectable dates in the timeline.

41. The computer program product of claim 40 further comprising:
twelfth program code, stored on the computer readable storage media, for identifying a selection of a particular employee in the group of employees; and
thirteenth program code, stored on the computer readable storage media, for obscuring trailing images for other employees in the group of employees and displaying trailing images in the chart for the particular employee in response to identifying the selection of the particular employee, wherein the trailing images the particular employee indicate change in performance for the particular employee over the number of selectable dates in the timeline.

42. The computer program product of claim 31, wherein the two axis chart comprises a plurality of boxes arranged in a grid, the locations for the group of employees being within the plurality of boxes.

43. The computer program product of claim 42, wherein the plurality of boxes is 9 boxes arranged in a 3×3 grid.

44. The computer program product of claim 31, wherein the group of employees is a plurality of employees.

45. The computer program product of claim 44, wherein the plurality of employees comprises a first department of a plurality of departments of employees within a corporation.
